(19) United States
(12) Patent Application Publication
(10) Pub. No.: US 2020/0112759 A1
(43) Pub. Date: Apr. 9, 2020

(54) Control Interface Accessory with Monitoring Sensors and Corresponding Methods

(71) Applicant: Motorola Mobility LLC, Chicago, IL (US)

(72) Inventors: Rachid Alameh, Crystal Lake, IL (US); Zhengping Ji, Hinsdale, IL (US); John Gorsica, Round Lake, IL (US); Thomas Gitzinger, Libertyville, IL (US)

(21) Appl. No.: 16/154,579

(22) Filed: Oct. 8, 2018

(51) Int. Cl. H04N 21/422; H04N 21/454; H04N 21/6587; G06F 3/01; G06F 3/16

(52) U.S. Cl. CPC H04N 21/42201; H04N 21/42202; H04N 21/42222; G06F 3/165; H04N 21/6587; G06F 3/013; H04N 21/454

(57) ABSTRACT

An interface accessory includes one or more sensors and one or more processors operable with the one or more sensors. An output connector can be mechanically and electrically connectable to a media consumption device. The sensor monitor one or more persons within a predefined media consumption environment about the media consumption device. The one or more processors deliver control signals to the output connector. The control signals alter a content presentation characteristic of content being presented by the media consumption device as a function of one or more personal characteristics corresponding to the one or more persons when the output connector is coupled to the media consumption device.

### BACKGROUND

### Technical Field

This disclosure relates generally to electronic devices, and more particularly to electronic interface devices that are operative with other electronic devices.

### Background Art

With the rise of modern electronic devices, such as smartphones, laptop computers, and tablet computers, offering an ever increasing number of options for consuming content such as pictures, videos, television shows, and movies, a large number of consumers still consume such content in a more traditional manner: by watching a television screen or other similar monitor. These monitors or television screens generally do not include sophisticated electronics, and are instead responsive to controls disposed on their housings or remote control devices. While the size of such devices makes viewing content easy for multiple persons within a room, the manual operations of selecting content can be cumbersome. It would be advantageous to have an improved user interface for content consumption devices.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory interface accessory in accordance with one or more embodiments of the disclosure.

FIG. 2 illustrates one explanatory system in accordance with one or more embodiments of the disclosure.

FIG. 3 illustrates one explanatory method in accordance with one or more embodiments of the disclosure.

FIG. 4 illustrates one or more method steps in accordance with one or more embodiments of the disclosure.

FIG. 5 illustrates another explanatory method in accordance with one or more embodiments of the disclosure.

FIG. 6 illustrates one or more method steps in accordance with one or more embodiments of the disclosure.

FIG. 7 illustrates yet another explanatory method in accordance with one or more embodiments of the disclosure.

FIG. 8 illustrates one or more method steps in accordance with one or more embodiments of the disclosure.

FIG. 9 illustrates another explanatory method in accordance with one or more embodiments of the disclosure.

FIG. 10 illustrates still more explanatory method steps in accordance with one or more embodiments of the disclosure.

FIG. 11 illustrates another explanatory method in accordance with one or more embodiments of the disclosure.

FIG. 12 illustrates still more method steps in accordance with one or more embodiments of the disclosure.

FIG. 13 illustrates another explanatory method in accordance with one or more embodiments of the disclosure.

FIG. 14 illustrates one or more method steps in accordance with one or more embodiments of the disclosure.

FIG. 15 illustrates yet another method in accordance with one or more embodiments of the disclosure.

FIG. 16 illustrates another method in accordance with one or more embodiments of the disclosure.

FIG. 17 illustrates additional method steps in accordance with one or more embodiments of the disclosure.

FIG. 18 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to detecting, with one or more sensors of an interface accessory, one or more persons within a predefined media consumption environment and delivering, with one or more processors of the interface accessory, a control signal to an electrically coupled media consumption device to alter a content presentation of content as a function of the persons who are within the predefined media consumption environment. Any process descriptions or blocks in flow charts should be understood as representing modules, segments, or portions of code that include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of generating control signals that alter the presentation of content in a media consumption device as a function of one or more personal characteristics corresponding to one or more persons within a predefined media consumption environment of an interface accessory as described herein. The non-processor circuits may include, but are not limited to, a radio receiver, a radio transmitter, signal drivers, clock circuits, power source circuits, and user input devices. As such, these functions may be interpreted as steps of a method to perform the delivery of control signals that adjust, for example, a volume level of a media consumption device as a function of different distances or lessened hearing conditions of one or more persons disposed within a media consumption environment of an interface accessory.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially” and “about” are used to refer to dimensions, orientations, or alignments inclusive of manufacturing tolerances. Thus, a “substantially orthogonal” angle with a manufacturing tolerance of plus or minus two degrees would include all angles between 88 and 92, inclusive. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide an interface accessory that includes a housing, one or more sensors, one or more processors operable with the one or more sensors, and an output connector suitable for mechanically and electrically coupling the interface accessory to a media consumption device such as a television screen or other similar monitor. In one or more embodiments, the one or more sensors monitor a predefined media consumption environment about the interface accessory. AS one or more persons enter, are in, or exit the predefined media consumption environment, the one or more processors deliver control signals to the media consumption device.

This “alteration” of the content occurs, in one or more embodiments, as a function of one or more personal characteristics corresponding to the one or more persons who are in the predefined media consumption environment. Illustrating by example, when a person is watching an adult-rated movie and a minor enters the predefined media consumption environment, the one or more processors may deliver a control signal to pause the movie or change it to child-friendly content, and so forth.

Advantageously, the interface accessory and corresponding methods and systems provide users with a live and seamless process to enhance their media consumption environment. By including sensors such as an imager or camera in the interface accessory, along with facial recognition or other biometric recognition capabilities, the interface accessory can identify who is consuming content and can deliver control signals to the media consumption device to alter the content so that it is optimized for all users.

In one or more embodiments, the interface accessory has an imager that is capable of capturing images with a 180-degree field of view or multiple imagers that provide the right coverage and can be used for depth assessment. Alternatively, this imager can be augmented by a depth imager in some embodiments to allow the interface accessory to capture facial depth scans of one or more persons situated within the predefined media consumption environment. The interface accessory can advantageously include an output connector that is mechanically and electrically capable of coupling to a media consumption device, thereby allowing it to draw power from the media consumption device and thus not require batteries.

In one or more embodiments, when a person situated within the predefined media consumption environment is watching a rated movie, the interface accessory can, upon detecting a minor entering the predefined media consumption environment, generate a control signal altering a content presentation characteristic of the movie by pausing the movie. Similarly, when a person within the predefined media consumption environment is watching a sporting event, the interface accessory can generate a control signal altering a content presentation characteristic of the game by pausing the game when the sensors of the interface accessory detect the person leaving the predefined media consumption environment to grab a drink, answer the door, or go to the washroom. The interface accessory can then generate another control signal to alter a content presentation characteristic of the content by causing playback of the game to resume when the one or more sensors detect the user re-entering the predefined media consumption environment.

In one or more embodiments, the interface accessory grants different levels of access to content as a function of which people are within the predefined media consumption environment. Illustrating by example, in one or more embodiments the one or more sensors of the interface accessory can detect which persons within the predefined media consumption environment are looking at the media consumption device, as well as identify them by facial recognition or other passive biometric identification techniques, thereby determining which people are in a room, whether they are watching the media consumption device, and who they are. If one was a minor, for example, and was trying to access a streaming media service, that minor may only be able to stream kid-friendly movies, and so forth.

In one or more embodiments, the interface accessory determines, from its one or more sensors, whether persons within the predefined media consumption environment are gazing toward the media consumption device while either carrying a remote control or attempting to control the media consumption device with voice commands. When such activity is detected, in one or more embodiments the interface accessory grants different levels of access to content based upon the identification of the person within the predefined media consumption environment who is carrying the remote or otherwise attempting to control the media consumption device. Thus, a minor accessing a streaming movie service with the remote control who is looking at the media consumption device while doing so as they search or scroll or navigate will find that certain movies are not selectable, and that only child-friendly movies are capable of being selected and streamed.

In one or more embodiments, the interface accessory determines, from its one or more sensors, whether persons within the predefined media consumption environment are gazing toward the media consumption device while either carrying a remote control or attempting to control the media consumption device with voice commands. When such activity is detected, in one or more embodiments the interface accessory bypasses permission access levels as a function of the captured identification of the person within the predefined media consumption environment who is carrying the remote or otherwise attempting to control the media consumption device while other persons are also within the predefined media consumption environment. Thus, for example, when a minor is accessing a streaming movie service with the remote control while looking at the media consumption device and searching or scrolling or navigating, but while an adult or parent is also within the predefined media consumption environment and gazing at the media consumption device, access will be granted based upon the adult or parent rather than the minor. Advantageously, this will expand the minor's access to content by bypassing the minor's permission restrictions and instead offering content selections commensurate with the parent's permissions.

In one or more embodiments, the interface accessory includes an imager and a depth scanner. These sensors are operable to determine angles of persons situated within the predefined media consumption environment relative to the media consumption device, as well as distances of each person from the media consumption device. In one or more embodiments one or more processors use sound triangulation and ambient light analysis to automatically adjust brightness and volume levels as a function of background illumination and user position for best visibility and perception of sound.

In one or more embodiments, the interface accessory an imager and a depth scanner. These sensors are operable to determine distances of persons situated within the predefined media consumption environment from the media consumption device. One or more processors of the interface accessory can then generate control signals as a function of these distances and can deliver them to an output connector of the interface accessory. The control signals can then adjust a volume level output by the media consumption device as a function of the different distances relative to the media consumption device when the output connector is coupled to the media consumption device.

Illustrating by example, the one or more processors may compute an average for the different distances relative to the media consumption device of each person and then adjust the volume such that a person sitting the average distance from the media consumption device would experience an optimal audio experience. Alternatively, the control signals may adjust the audio such that the person closest to the media consumption device would not be overloaded by the audio output, thereby ensuring that they have an enjoyable audio experience, and so forth. In one or more embodiments, is a person close to the media consumption device and a person far from the media consumption device are watching a movie at the same time, the volume level output of the media consumption device can be adjusted as a function of the average distance so that the close person is not overwhelmed by the sound level, but that the person far from the electronic device can still hear. That means the close person will experience higher than normal levels to accommodate the far person.

In one or more embodiments, if the person far from the media consumption device decides to leave the media consumption environment, such as to get a snack or answer the phone or door, this action is detected by the sensors of the interface accessory. When this occurs, the one or more processors of the interface accessory can then generate another control signal to bring down the volume level output so that the person closer to the media consumption device can experience a lower, more comfortable sound level. In one or more embodiments, when a person within the predefined media consumption environment has a hearing impairment or has a lessened hearing condition, the one or more processors can generate a control signal causing adjustment of the volume level output of the media consumption device to increase the same to compensate for the lessened hearing condition.

In one or more embodiments, the interface accessory includes audio input devices to detect audio signals identifying predefined situations such as a telephone ringing, a doorbell, a knock at the door, or people engaging in a conversation. In one or more embodiments, the one or more processors can generate, in response to detecting the predefined situation, a control signal causing adjustment of the volume level output of the media consumption device to decrease the volume during the duration of the predefined situation. Upon detecting a termination of the predefined condition, in one or more embodiments, the one or more processors can generate a control signal causing the volume level output of the media consumption device to return to the level occurring prior to the predefined situation.

In one or more embodiments, the one or more processors of the interface accessory include an Artificial Intelligence engine (AI engine) that is operable with the various sensors of the interface accessory. The AI engine can be configured via coded instructions to recognize and identify users and their habits, e.g., what content they consume, when they consume this content, who consumes content with them, and so forth. This AI engine can then associate predefined preferences with each person. The AI engine might, for instance, associate media consumption device settings, lighting, loudness, preferred sitting locations, and so forth, with each user. This can be used to deliver control signals to the media consumption device to accommodate these predefined preferences when a particular user enters the predefined media consumption environment.

In one or more embodiments, the interface accessory includes at least two ultrasound transducers that allow audio signals to be delivered to specific locations where outputs from the ultrasound transducers intersect and generate an audible beat. This allows audio to be steered in situations where not everyone within the room or other predefined media consumption environment wants to hear the audio associated with particular content. Advantageously, when the output from at least two ultrasound transducers converges in a specific location, a particular user can give a command such as speaking the words, “play here.” When this occurs, audio input devices of the interface accessory can receive and assess this audible command. (It should be noted that when the user gives the command “play here,” this can be received by normal audio transducers, which in turn determine a location by audible transducer triangulation to control the ultrasound transducers physical pointing direction, which can be motorized.) Alternatively, an imager can analyze lip movement from captured images to identify the voice command. Regardless of how the voice command is received, in one or more embodiments the directional output of each ultrasound transducer can be adjusted to point at, and define, a sound “beat spot” at the location where the user uttering the voice command is located. This allows that user to hear audio while others nap, read the paper, knit, crochet, work crossword puzzles, and so forth.

In alternate embodiments, the location at which the directional audio output from the ultrasound transducers intersect can be controlled as a function of the distance of the person nearest the media consumption device, as detected by an imager or other sensor. Additionally, rather than using a voice command such as “play here,” in other embodiments a person can carry a companion device, such as a smart watch or fob that can be used as a directional beacon to determine where the intersection of the directional audio output from the ultrasound transducers will occur. Again, multi audible transducers can be steered via phase shift, ultrasonic transducers are based on a beat principle where it becomes audible where two ultrasound transducers meet in physical space. As an added feature, in still other embodiments imagers of the interface accessory can capture and detect hand or other gestures from people to determine where the intersection of the directional audio output from the ultrasound transducers will occur. This approach can be advantageous in noisy environments where the integrity of voice commands received by the audio input devices is lower than desirable.

In one or more embodiments, the one or more processors of the interface accessory can make content recommendations, filtering and selecting based upon user preferences after identifying a person or persons being within the predefined media consumption environment. In one or more embodiments, the one or more processors of the interface accessory can remember the media consumption habits of a particular user, as well as particular content offerings that an identified person likes. This data can be stored using the AI engine and/or machine learning to help make content recommendations for users and/or automate program selection when a person is identified within the predefined media consumption environment. Other features and functions for the interface accessory will be obvious to those of ordinary skill in the art having the benefit of this disclosure.

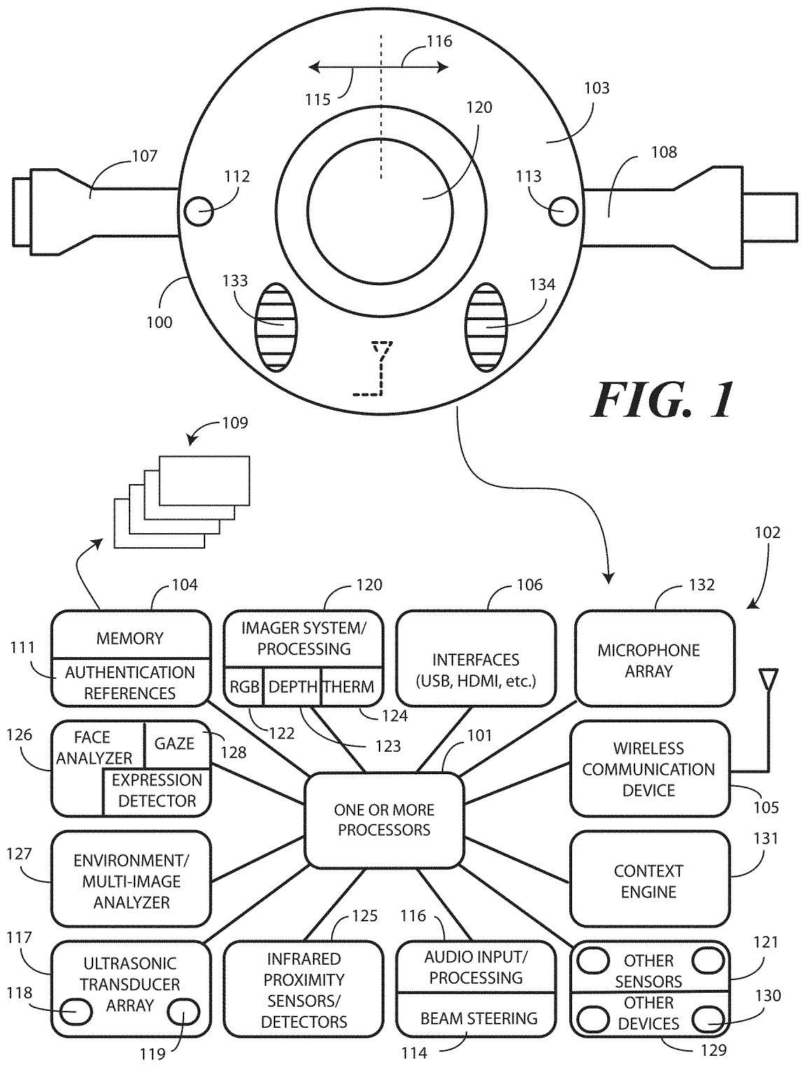

Turning now to FIG. 1, illustrated therein is one explanatory interface accessory 100 in accordance with one or more embodiments of the disclosure. Also illustrated in FIG. 1 is one explanatory block diagram schematic 102 of the explanatory interface accessory 100 of FIG. 1. In one or more embodiments, the block diagram schematic 102 is configured as a printed circuit board assembly disposed within a housing 103 of the interface accessory 100. Various components can be electrically coupled together by conductors or a bus disposed along one or more printed circuit boards.

The illustrative block diagram schematic 102 of FIG. 1 includes many different components. Embodiments of the disclosure contemplate that the number and arrangement of such components can change depending on the particular application. Accordingly, electronic devices configured in accordance with embodiments of the disclosure can include some components that are not shown in FIG. 1, and other components that are shown may not be needed and can therefore be omitted.

In one embodiment, the interface accessory 100 includes one or more processors 101. In one embodiment, the one or more processors 101 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device. The application processor and the auxiliary processor(s) can be operable with the various components of the block diagram schematic 102. Each of the application processor and the auxiliary processor(s) can be configured to process and execute executable software code to perform the various functions of the interface accessory 100 with which the block diagram schematic 102 operates. A storage device, such as memory 104, can optionally store the executable software code used by the one or more processors 101 during operation.

In this illustrative embodiment, the block diagram schematic 102 also includes a communication circuit 105 that can be configured for wired or wireless communication with one or more other devices or networks. The communication circuit can be operable with one or more device connectors 106 that are operable to mechanically and/or electrically couple to another electronic device, such as a media consumption device. Examples of such media consumption devices include television displays, black and white or color video monitors, or other devices upon which visual output can be delivered to a user. Examples of device connectors 106 include physical connectors such as input connectors 107 and output connectors 108. These input connectors 107 and output connectors 108 can be Universal Serial Bus (USB) connectors, High Definition Multimedia Interface (HDMI) connectors, RCA or cinch connectors, 3.5 millimeter connectors, quarter-inch connectors, and coaxial connectors. Other types of connectors will be obvious to those of ordinary skill in the art having the benefit of this disclosure.

The networks with which the communication circuit 105 can be operable include a wide area network, a local area network, and/or personal area network. Examples of wide area networks include GSM, CDMA, W-CDMA, CDMA-2000, iDEN, TDMA, 2.5 Generation 3GPP GSM networks, 3rd Generation 3GPP WCDMA networks, 3GPP Long Term Evolution (LTE) networks, and 3GPP2 CDMA communication networks, UMTS networks, E-UTRA networks, GPRS networks, iDEN networks, and other networks. The communication circuit 105 may also utilize wired or wireless technology for communication, such as, but are not limited to, peer-to-peer or ad hoc communications such as HomeRF, Bluetooth and IEEE 802.11 (a, b, g or n); and other forms of wireless communication such as infrared technology. The communication circuit 105 can include wired or wireless communication circuitry, one of a receiver, a transmitter, or transceiver, and one or more antennas.

In one embodiment, the one or more processors 101 can be responsible for performing the primary functions of the interface accessory 100 with which the block diagram schematic 102 is operational. For example, in one embodiment the one or more processors 101 comprise one or more circuits operable with one or more sensors of the interface accessory 100 to receive information from one or more persons situated within a predefined environment. The executable software code used by the one or more processors 101 can be configured as one or more modules 109 that are operable with the one or more processors 101. Such modules 109 can store instructions, control algorithms, and so forth.

In one or more embodiments, the block diagram schematic 102 includes an audio input/processor 110. The audio input/processor 110 is operable to receive audio input from an environment about the interface accessory 100. The audio input/processor 110 can include hardware, executable code, and speech monitor executable code in one embodiment. The audio input/processor 110 can be operable with one or more predefined authentication references 111 stored in memory 104.

With reference to audio input, the predefined authentication references 111 can comprise representations of basic speech models, representations of trained speech models, or other representations of predefined audio sequences that are used by the audio input/processor 110 to receive and identify voice commands that are received with audio input captured by an audio capture device, such as one or more microphones 112,113. Additional microphones could be added to the one or more microphones 112,113 to define a microphone array 132. In one embodiment, the audio input/processor 110 can include a voice recognition engine. Regardless of the specific implementation utilized in the various embodiments, the audio input/processor 110 can access various speech models stored with the predefined authentication references 111 to identify speech commands.

The audio input/processor 110 can include a beam steering engine 114 comprising the one or more microphones 112,113. Input from the one or more microphones 112,113 can be processed in the beam steering engine 114 such that the one or more microphones define a virtual microphone. This virtual microphone can define an acoustic reception cone that can be virtually “steered” around the interface accessory 100. Alternatively, actual steering can occur as well, such as switching between a left and right microphone or a front and back microphone, or switching various microphones ON and OFF individually. In one or more embodiments, two or more microphones 112,113 can be included for selective beam steering by the beam steering engine 114.

Illustrating by example, a first microphone, e.g., microphone 112, can be located on a first side 115 of the interface accessory 100 for receiving audio input from a first direction, while a second microphone, e.g., microphone 113, can be placed on a second side 116 of the interface accessory 100 for receiving audio input from a second direction. These microphones can be “steered” by selectively turning them ON and OFF.

The beam steering engine 114 can then select between the first microphone and the second microphone to beam steer audio reception toward an object, such as a user delivering audio input. This beam steering can be responsive to input from other sensors, such as imagers, facial depth scanners, thermal sensors, or other sensors. For example, an imager can estimate a location of a person's face and deliver signals to the beam steering engine 114 alerting it in which direction to focus the acoustic reception cone and/or steer the first microphone and the second microphone, thereby adding confirmation to audio steering and saving time. Where multiple people are around the interface accessory 100 or within a predefined environment within which one or more sensors of the interface accessory 100 can reliably receive inputs this steering advantageously directs a beam reception cone to a person uttering voice commands.

Alternatively, the beam steering engine 114 processes and combines the signals from two or more microphones to perform beam steering. The one or more microphones 112,113 can be used for voice commands. In response to control of the one or more microphones 112,113 by the beam steering engine 114, a user location direction can be determined. The beam steering engine 114 can then select between the first microphone and the second microphone to beam steer audio reception toward the user. Alternatively, the audio input/processor 110 can employ a weighted combination of the microphones to beam steer audio reception toward the user.

In one embodiment, the audio input/processor 110 is configured to implement a voice control feature that allows a user to speak a specific device command to cause the one or more processors 101 to execute a control operation. For example, the user may say, “play here” to cause one or more ultrasonic transducers 118,119 of an ultrasonic transducer array 117 to deliver audio signals to specific locations where outputs from the ultrasonic transducers 118,119 intersect. This allows audio to be steered to locations where selected persons are situated within a predefined environment. Advantageously, a particular user can give a command such as speaking the words, “play here.” When this occurs, the one or more microphones 112,113 can receive and assess this audible command. In one or more embodiments the directional output of each ultrasonic transducer 118,119 can be adjusted to point at, and define, a sound “beat spot” at the location where the user uttering the voice command is situated. This allows that user to hear audio while other persons within the predefined environment do other activities. Also, the imager and/or depth imager can be used to determine a user location and confirm user is the speaker of “play here” via lip movement. That causes, in one embodiment, the ultrasound transducers to be pointed toward user.

In addition to being used to direct ultrasonic transducers 118,119 of an ultrasonic transducer array 117, voice commands can be used to authenticate a person situated within a predefined environment about the interface accessory 100 as well. Illustrating by example, a person might say “authenticate me.” In one or more embodiments, this statement comprises a device command requesting the one or more processors 101 to cooperate with an authentication system 120 to authenticate a user. Consequently, this device command can cause the one or more processors 101 to access the authentication system 120 and begin the authentication process. In short, in one embodiment the audio input/processor 110 listens for voice commands, processes the commands and, in conjunction with the one or more processors 101, executes control operations in response to the voice input.

The one or more processors 101 can perform filtering operations on audio input received by the audio input/processor 110. For example, in one embodiment the one or more processors 101 can filter the audio input into authorized user generated audio input, i.e., first audio input, and other audio input, i.e., second audio input.

The authentication system 120 is operable with the one or more processors 101. Various sensors 121 can be operable with the one or more processors 101 as well. For example, a first sensor can include an imager 122. A second optional sensor can include a depth imager 123. A third optional sensor can include a thermal sensor 124.

In one embodiment, the imager 122 comprises a two-dimensional imager configured to receive at least one image of a person within an environment of the interface accessory 100. In one embodiment, the imager 122 comprises a two-dimensional Red-Green-Blue (RGB) imager. In another embodiment, the imager 122 comprises an infrared imager. Other types of imagers suitable for use as the imager 122 of the authentication system will be obvious to those of ordinary skill in the art having the benefit of this disclosure.

The thermal sensor 124, where included, can also take various forms. In one embodiment, the thermal sensor 124 is simply a proximity sensor component included with one or more infrared proximity sensors or detectors 125 of the interface accessory 100. In another embodiment, the thermal sensor 124 comprises a simple thermopile. In another embodiment, the thermal sensor 124 comprises an infrared imager that captures the amount of thermal energy emitted by an object. Other types of thermal sensors 124 will be obvious to those of ordinary skill in the art having the benefit of this disclosure.

The depth imager 123, where included, can take a variety of forms. In a first embodiment, the depth imager 123 comprises a pair of imagers separated by a predetermined distance, such as three to four images. This “stereo” imager works in the same way the human eyes do in that it captures images from two different angles and reconciles the two to determine distance.

In another embodiment, the depth imager 123 employs a structured light laser. The structured light laser projects tiny light patterns that expand with distance. These patterns land on a surface, such as a user's face, and are then captured by an imager. By determining the location and spacing between the elements of the pattern, three-dimensional mapping can be obtained.

In still another embodiment, the depth imager 123 comprises a time of flight device. Time of flight three-dimensional sensors emit laser or infrared pulses from a photodiode array. These pulses reflect back from a surface, such as the user's face. The time it takes for pulses to move from the photodiode array to the surface and back determines distance, from which a three-dimensional mapping of a surface can be obtained. Regardless of embodiment, the depth imager adds a third “z-dimension” to the x-dimension and y-dimension defining the two-dimensional image captured by the imager 122, thereby enhancing the security of using a person's face as their password in the process of authentication by facial recognition.

In one or more embodiments, the authentication system 120 can be operable with a face analyzer 126 and an environmental analyzer 127. The face analyzer 126 and/or environmental analyzer 127 can be configured to process an image or depth scan of an object and determine whether the object matches predetermined criteria by comparing the image or depth scan to one or more predefined authentication references 111 stored in memory 104.

For example, the face analyzer 126 and/or environmental analyzer 127 can operate as an authentication module configured with optical and/or spatial recognition to identify objects using image recognition, character recognition, visible recognition, facial recognition, color recognition, shape recognition, and the like. Advantageously, the face analyzer 126 and/or environmental analyzer 127, operating in tandem with the authentication system 120, can be used as a facial recognition device to determine the identity of one or more persons detected about the interface accessory 100.

In one embodiment when the authentication system 120 detects a person, one or both of the imager 122 and/or the depth imager 123 can capture a photograph and/or depth scan of that person. The authentication system 120 can then compare the image and/or depth scan to one or more predefined authentication references 111 stored in the memory 104. This comparison, in one or more embodiments, is used to confirm beyond a threshold authenticity probability that the person's face—both in the image and the depth scan—sufficiently matches one or more of the predefined authentication references 111 stored in the memory 104 to authenticate a person as an authorized user of the interface accessory 100.

Beneficially, this optical recognition performed by the authentication system 120 operating in conjunction with the face analyzer 126 and/or environmental analyzer 127 allows access to the interface accessory 100 only when one of the persons detected about the interface accessory 100 are sufficiently identified as being situated within a predefined environment of the interface accessory 100. Accordingly, in one or more embodiments the one or more processors 101, working with the authentication system 120 and the face analyzer 126 and/or environmental analyzer 127 can determine whether at least one image captured by the imager 122 matches a first predefined criterion, whether at least one facial depth scan captured by the depth imager 123 matches a second predefined criterion, and whether the thermal energy identified by the thermal sensor 124 matches a third predefined criterion, with the first criterion, second criterion, and third criterion being defined by the reference files and predefined temperature range. The first criterion may be a skin color, eye color, and hair color, while the second criterion is a predefined facial shape, ear size, and nose size. The third criterion may be a temperature range of between 95 and 101 degrees Fahrenheit. In one or more embodiments, the one or more processors 101 authenticate and/or identify a person within a predefined environment of the interface accessory 100 when the at least one image matches the first predefined criterion, the at least one facial depth scan matches the second predefined criterion, and the thermal energy matches the third predefined criterion.

In one or more embodiments, a user can “train” the interface accessory 100 by storing predefined authentication references 111 in the memory 104 of the interface accessory 100. Illustrating by example, a user may take a series of pictures. They can include identifiers of special features such as eye color, sink color, air color, weight, and height. They can include the user standing in front of a particular wall, which is identifiable by the environmental analyzer from images captured by the imager 122. They can include the user raising a hand, touching hair, or looking in one direction, such as in a profile view. These can then be stored as predefined authentication references 111 in the memory 104 of the interface accessory 100.

A gaze detector 128 can be operable with the authentication system 120 operating in conjunction with the face analyzer 126. The gaze detector 128 can comprise sensors for detecting the user's gaze point. The gaze detector 128 can optionally include sensors for detecting the alignment of a user's head in three-dimensional space. Electronic signals can then be processed for computing the direction of user's gaze in three-dimensional space. The gaze detector 128 can further be configured to detect a gaze cone corresponding to the detected gaze direction, which is a field of view within which the user may easily see without diverting their eyes or head from the detected gaze direction. The gaze detector 128 can be configured to alternately estimate gaze direction by inputting images representing a photograph of a selected area near or around the eyes. It will be clear to those of ordinary skill in the art having the benefit of this disclosure that these techniques are explanatory only, as other modes of detecting gaze direction can be substituted in the gaze detector 128 of FIG. 1.

The face analyzer 126 can include its own image/gaze detection-processing engine as well. The image/gaze detection-processing engine can process information to detect a user's gaze point. The image/gaze detection-processing engine can optionally also work with the depth scans to detect an alignment of a user's head in three-dimensional space. Electronic signals can then be delivered from the imager 122 or the depth imager 123 for computing the direction of user's gaze in three-dimensional space. The image/gaze detection-processing engine can further be configured to detect a gaze cone corresponding to the detected gaze direction, which is a field of view within which the user may easily see without diverting their eyes or head from the detected gaze direction. The image/gaze detection-processing engine can be configured to alternately estimate gaze direction by inputting images representing a photograph of a selected area near or around the eyes. It can also be valuable to determine if the user wants to be authenticated by looking directly at device. The image/gaze detection-processing engine can determine not only a gazing cone but also if an eye is looking in a particular direction to confirm user intent to be authenticated.

Other components 129 operable with the one or more processors 101 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as one or more loudspeakers 133,134, which may optionally be disposed a speaker port. Still other examples of output components include or other alarms and/or buzzers and/or a mechanical output component such as vibrating or motion-based mechanisms.

The other components 129 can also include one or more proximity sensors or detectors 125. In one or more embodiments, these devices fall in to one of two camps: active proximity sensors and “passive” proximity sensors. Either the proximity detector components or the proximity sensor components can be generally used for gesture control and other user interface protocols, some examples of which will be described in more detail below.

As used herein, a “proximity sensor component” comprises a signal receiver only that does not include a corresponding transmitter to emit signals for reflection off an object to the signal receiver. A signal receiver only can be used due to the fact that a user's body or other heat generating object external to device, such as a wearable electronic device worn by user, serves as the transmitter. Illustrating by example, in one the proximity sensor components comprise a signal receiver to receive signals from objects external to the housing 103 of the interface accessory 100. In one embodiment, the signal receiver is an infrared signal receiver to receive an infrared emission from an object such as a human being when the human is proximately located with the interface accessory 100. In one or more embodiments, the proximity sensor component is configured to receive infrared wavelengths of about four to about ten micrometers. This wavelength range is advantageous in one or more embodiments in that it corresponds to the wavelength of heat emitted by the body of a human being.

Additionally, detection of wavelengths in this range is possible from farther distances than, for example, would be the detection of reflected signals from the transmitter of a proximity detector component. In one embodiment, the proximity sensor components have a relatively long detection range so as to detect heat emanating from a person's body when that person is within a predefined thermal reception radius. For example, the proximity sensor component may be able to detect a person's body heat from a distance of about fifteen feet in one or more embodiments. The ten-foot dimension can be extended as a function of designed optics, sensor active area, gain, lensing gain, and so forth.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level. Simulations show that a group of infrared signal receivers can operate with a total current drain of just a few microamps.

In one embodiment, the signal receiver of each proximity sensor component can operate at various sensitivity levels so as to cause the at least one proximity sensor component to be operable to receive the infrared emissions from different distances. For example, the one or more processors 101 can cause each proximity sensor component to operate at a first “effective” sensitivity so as to receive infrared emissions from a first distance. Similarly, the one or more processors 101 can cause each proximity sensor component to operate at a second sensitivity, which is less than the first sensitivity, so as to receive infrared emissions from a second distance, which is less than the first distance. The sensitivity change can be effected by causing the one or more processors 101 to interpret readings from the proximity sensor component differently.

By contrast, proximity detector components include a signal emitter and a corresponding signal receiver, which constitute an “active IR” pair. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers. The infrared transmitters are configured, in one embodiment, to transmit infrared signals having wavelengths of about 860 nanometers, which is one to two orders of magnitude shorter than the wavelengths received by the proximity sensor components. The proximity detector components can have signal receivers that receive similar wavelengths, i.e., about 860 nanometers.

In one or more embodiments, each proximity detector component can be an infrared proximity sensor set that uses a signal emitter that transmits a beam of infrared light that reflects from a nearby object and is received by a corresponding signal receiver. Proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

The other components 129 can also optionally include a light sensor 130 that detects changes in optical intensity, color, light, or shadow in the environment of an electronic device. This can be used to make inferences about context such as illumination levels within a predefined environment disposed about the interface accessory 100, colors on walls, and so forth. An infrared sensor can be used in conjunction with, or in place of, the light sensor 130. The infrared sensor can be configured to detect thermal emissions from an environment about the interface accessory 100. Similarly, a temperature sensor can be configured to monitor temperature about an electronic device.

A context engine 131 can then operable with the various sensors to detect, infer, capture, and otherwise determine persons and actions that are occurring in an environment about the interface accessory 100. For example, where included one embodiment of the context engine 131 determines assessed contexts and frameworks using adjustable algorithms of context assessment employing information, data, and events. These assessments may be learned through repetitive data analysis. Alternatively, may deliver various inputs to the one or more sensors 121, or constructs, rules, and/or paradigms, which instruct or otherwise guide the context engine 131 in detecting multi-modal social cues, emotional states, moods, and other contextual information. The context engine 131 can comprise an artificial neural network or other similar technology in one or more embodiments.

In one or more embodiments, the context engine 131 is operable with the one or more processors 101. In some embodiments, the one or more processors 101 can control the context engine 131. In other embodiments, the context engine 131 can operate independently, delivering information gleaned from detecting multi-modal social cues, emotional states, moods, and other contextual information to the one or more processors 101. The context engine 131 can receive data from the various sensors. In one or more embodiments, the one or more processors 101 are configured to perform the operations of the context engine 131.

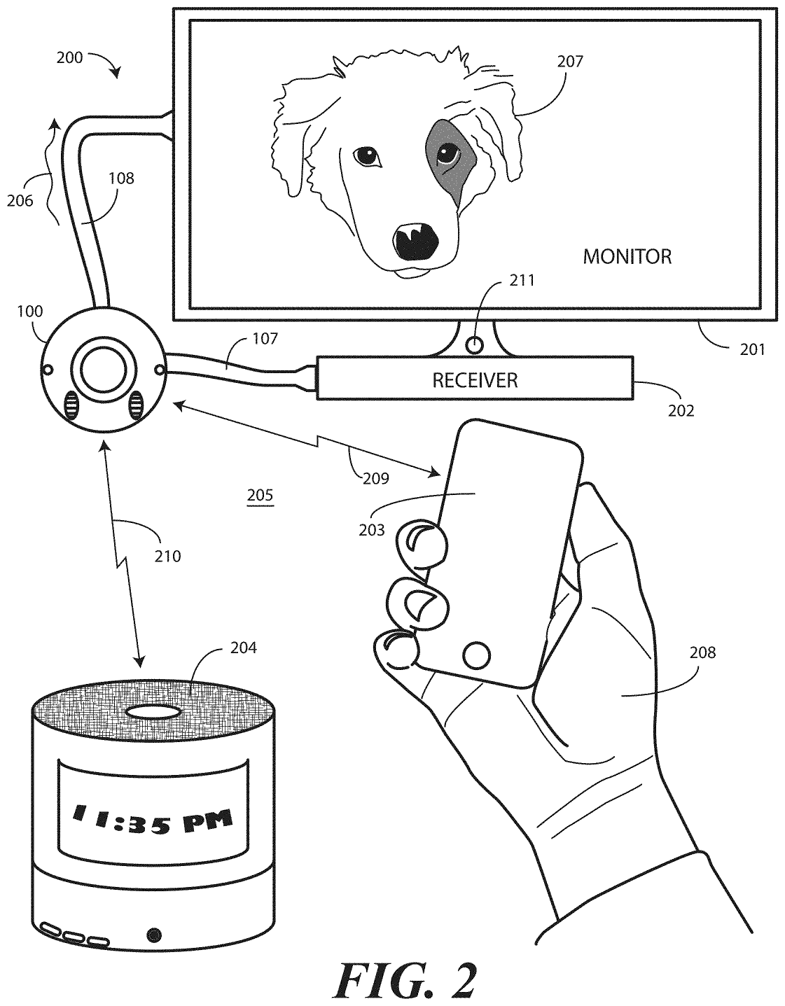

Turning now to FIG. 2, illustrated therein is one explanatory system 200 within which the interface accessory 100 may be used. As shown in FIG. 2, the interface accessory 100 is coupled between a media consumption device 201, which in this case is a color video monitor, and a media reception device 202, which is shown as a set-top box configured to receive content from a terrestrial broadcast network, cable television network, Internet streaming service, or combinations thereof. In this illustrative embodiment, the input connector 107 of the interface accessory 100 is coupled to the media reception device 202, while the output connector 108 is coupled to the media consumption device 201.

In one or more embodiments, content flows from the media reception device 202, through the interface accessory 100, and to the media consumption device 201. In other embodiments, content will flow from the media reception device 202 directly to the media consumption device 201, while the interface accessory 100 provides a parallel connection for signals to pass from the interface accessory to or from one or both of the media reception device 202 and the media consumption device 201. In still another embodiment, the input connector 107 of the interface accessory 100 will be omitted, with only the output connector 108 coupled to either the media consumption device 201 or the media reception device 202.

In one or more embodiments, the one or more processors (101) of the interface accessory 100 are operable to deliver one or more control signals 206 to one or both of the media reception device 202 or the media consumption device 201 to alter a content presentation characteristic of content 207 being presented by the media consumption device 201. In one or more embodiments this alteration of content presentation characteristics occurs when the output connector 108 is coupled to one or both of the media reception device 202 or the media consumption device 201.

As will be described in more detail below with reference to the subsequent methods and method steps, this alteration of content presentation characteristics occurs as a function of one or more personal characteristics corresponding to one or more persons being physically situated within a predefined environment 205 of the interface accessory 100 within which the one or more sensors (121) of the interface accessory 100 can reliably receive input from the persons. These personal characteristics can include characteristics such as whether a person is a minor, whether a person is gazing toward a media consumption device, whether a person is an adult, whether a person is holding a companion device such as a remote control, whether a person has a lessened hearing condition of hearing impairment, a distance or angle at which the person is situated relative to the media consumption device, the fact that a person exits a predefined media consumption environment, and so forth. Other examples of personal characteristics will be described below. Still others will be obvious to those of ordinary skill in the art having the benefit of this disclosure.

In many embodiments, the predefined environment 205 will be defined by physical boundaries, such as walls of a room in which the system 200 is placed. This will be the case for sensors such as the imager (122). However, for other sensors such as wireless communication circuitry, this predefined environment 205 will be much larger. Accordingly, in one or more embodiments the predefined environment 205 will change as a function of the sensor with which it is being referenced.

Where wireless communication capabilities are included with the communication circuit (105), the interface accessory 100 can optionally be in communication with other electronic devices. For example, in this illustration the interface accessory 100 is operable with a smartphone 203 belonging to a person 208. The interface accessory 100 can exchange electronic signals 209 with the smartphone 203 to identify the person 208 and/or receive commands and instructions from the person 208. Similarly, the interface accessory can be operable with other electronic devices such as a voice assistant 204. The interface accessory 100 can exchange other electronic signals 210 with the voice assistant to further identify the person 208 and/or receive commands and instructions from the person 208.

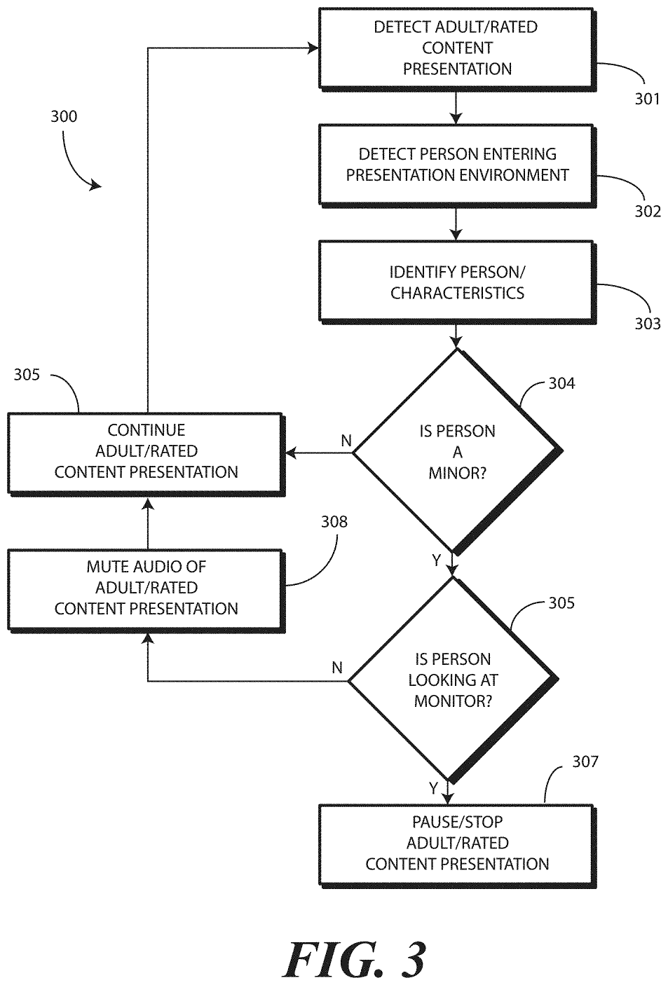

In one or more embodiments, the interface accessory 100 can deliver control signals 206 to the output connector 108 to alter how content 207 is presented on the media consumption device 201. As noted above, these control signals 206 can be a function of whether anyone is within the predefined environment 205, how many people are in the predefined environment 205, and the identity of the people situated within the predefined environment 205. How control signals 206 are generated will be illustrated in detail with reference to FIGS. 3-18 below. However, to illustrate by simple example, in one embodiment the one or more sensors (121) of the interface accessory 100 monitor one or more persons, e.g., person 208, within the predefined media consumption environment, which in this example is the same as the predefined environment 205, about the media consumption device 201. One or more processors (101) of the interface accessory 100 can then deliver control signals 206 to the output connector 108. In one or more embodiments, the control signals 206 alter a content presentation characteristic of content 207 being presented by the media consumption device 201 as a function of one or more personal characteristics corresponding to the one or more persons when the output connector 108 is coupled to the media consumption device 201.

In one embodiment, the control signals 206 pause presentation of the content 207 or restricting content offerings available for consumption at the media consumption device 201 when the one or more personal characteristics comprise at least one person within the predefined environment 205 being a minor. In another embodiment, the control signals 206 adjust a volume of an audio output 211 of the media consumption device 201 when the one or more personal characteristics comprise a person entering or leaving the predefined environment 205. As noted above, when the interface accessory 100 includes the ultrasonic transducer array (117), and when the one or more persons comprise at least a first person and at least a second person, the control signals 206 can cause a cessation of audio output by the media consumption device 201. When this occurs, the one or more processors (101) can further cause the ultrasonic transducer array (117) to deliver a beat audio output to the at least the first person that is inaudible to the at least the second person. These are merely examples of control signals 206 in accordance with embodiments of the disclosure. Others will be disclosed below. Still others will be obvious to those of ordinary skill in the art having the benefit of this disclosure.

Turning now to FIG. 3, illustrated therein is one method 300 for an interface accessory configured in accordance with one or more embodiments of the disclosure. Beginning at step 301, the method detects, with one or more sensors of the interface accessory, one or more persons being situated within a predefined media consumption environment of a media consumption device. In one or more embodiments, the predefined media consumption environment will be defined by a radius within which the one or more persons can satisfactorily consume media from the media consumption device. Illustrating by example, where the media consumption device is a television monitor, the predefined media consumption environment will be defined by a radius about the television monitor where the one or more persons can both legibly see the television monitor and audibly hear sound from the television monitor. As noted above, the sensors of the interface accessory can define an environment such as predefined environment (205) described above within which the sensors can reliably receive signals from one or more persons. It is frequently the case that the predefined media consumption environment will be smaller than this predefined environment (205) defined by the sensors. In many cases, the predefined media consumption environment will be defined by a room in which the media consumption device is placed. If, for example, the television monitor is placed in a family room, it is likely that anyone within the room can see and hear the television monitor. It is for this reason that the interface accessory can be equipped with an imager (122) that has a 180-degree field of view. In one or more embodiments, if a minor enters the predefined environment and is not gazing at the television monitor, the media content does not pause. Instead, the audio mutes.

At step 301, the method 300 also identifies the type of content being presented on the media consumption device. Illustrating by example, the content could be a sporting event, a movie, a television show, a home video, or other content. In one or more embodiments, the method 300 also determines a characteristic of the content being presented at step 301. In this illustration, that characteristic is that the content is rated or otherwise classified as being for adults only. For instance, the content might be a history of the Second World War that includes particularly graphic battle scenes that may be disturbing to children. If this content is a movie, it may be rated PG-13 or R due to this mature content. Accordingly, it may not be appropriate for minors. Thus, in one or more embodiments step 301 includes determining whether one or more persons are within a predefined media consumption environment, what content is being presented on the media consumption device, and a characteristic of the content being presented on the media consumption device.

At step 302, the method 300 detects, with one or more sensors of the interface accessory, a person entering predefined media consumption environment. At step 303, the method 300 identifies, with the one or more sensors of the interface accessory and in response to detecting the person entering the predefined media consumption environment, at least one personal characteristic corresponding to the person entering the predefined media consumption environment. For example, facial recognition, voice recognition, depth scan recognition, or other techniques described above can be used to identify the at least one personal characteristic at step 303. Examples of personal characteristics include the person entering the predefined media consumption environment being a minor, whether the person entering the predefined media consumption environment is gazing at the media consumption device, whether the person entering the predefined media consumption environment is holding a remote control device capable of controlling the media consumption device, whether the person has a lessened eyesight condition, whether the person has a lessened hearing condition, how far the person is from the media consumption device, the angle at which the person is relative to a planar surface or display of the media consumption device, what content preferences the person entering the predefined media consumption environment has, what content the person entering the predefined media consumption environment has watched in the past, when they have watched such content, and so forth. This list is illustrative only, and is not meant to be comprehensive. Numerous other personal characteristics corresponding to persons entering the predefined media consumption environment will be obvious to those of ordinary skill in the art having the benefit of this disclosure.

In this illustrative embodiment, at least one personal characteristic is whether the person entering the predefined media consumption environment is a minor, as determined at decision 304. Recall from above that step 301 of the method 300 determined that mature content was being presented on the media consumption device. Accordingly, this content may not be suitable for the minor entering the predefined media consumption environment.

At optional decision 305, the method 300 determines whether the person entering the predefined media consumption environment is gazing toward the media consumption device. Embodiments of the disclosure contemplate that if the person is a minor, as determined at decision 304, but is not looking at the media consumption device, they may not see, for example, the bloody battle scene of the World War II movie. However, embodiments of the disclosure contemplate that they may still be able to hear. Accordingly, while there may be no action to take regarding pausing the content, it may be desirable to optionally mute the audio at step 308. Another person may be in the predefined media consumption environment, and could thus continue watching the movie while listening to the audio on headphones. As such, the minor may be oblivious to what is occurring on the screen of the media consumption device.

However, where the person entering the predefined media consumption environment is a minor, and is looking at the media consumption device, or where optional decision 305 is omitted, in one or more embodiments one or more processors of the interface accessory deliver a control signal to an output connector of the interface accessory at step 307. Where optional decision 306 is included, i.e., where the method determines a gaze of the person entering the predefined media consumption environment toward the media consumption device, in one or more embodiments the delivery of the control signal occurs only when the person entering the predefined media consumption environment is gazing toward the media consumption device.

In one or more embodiments, the control signal alters a content presentation characteristic of content being presented by the media consumption device when the output connector is coupled to the media consumption device. In this illustrative example, the control signal causes the presentation of the mature content to pause or stop. As will be shown below, in other embodiments, the control signal causes the presentation of content to switch from a first type of content to a second type of content. For example, the control signal could cause the presentation of PG-13 or R-rated content to switch to G-rated content, and so forth. Advantageously, embodiments of the disclosure set forth in FIG. 3 detect the presentation of mature content, detect a minor entering a delivering, with one or more processors of the interface accessory, a control signal to an output connector of the interface accessory, the control signal altering a content presentation characteristic of content being presented by the media consumption device when the output connector is coupled to the media consumption device, and then pause or stop the presentation of the mature content so that the minor can be spared the stress of being exposed to content not well suited for their age.

By contrast, if the person is not a minor, or if optional decision 306 is included and the minor is not looking at the media consumption device, in one or more embodiments the method 300 moves to step 305 where the mature content continues being presented. When this occurs, and where optional decision 306 is included, it is well to note that the method 300 can continue to monitor the minor's actions within the predefined media consumption environment. If, for example, the minor is initially not looking at the media consumption device, but later turns their head at looks at the media consumption device, this can be detected at decision 306. The method 300 can then move to step 307 where the mature content is paused or stopped.

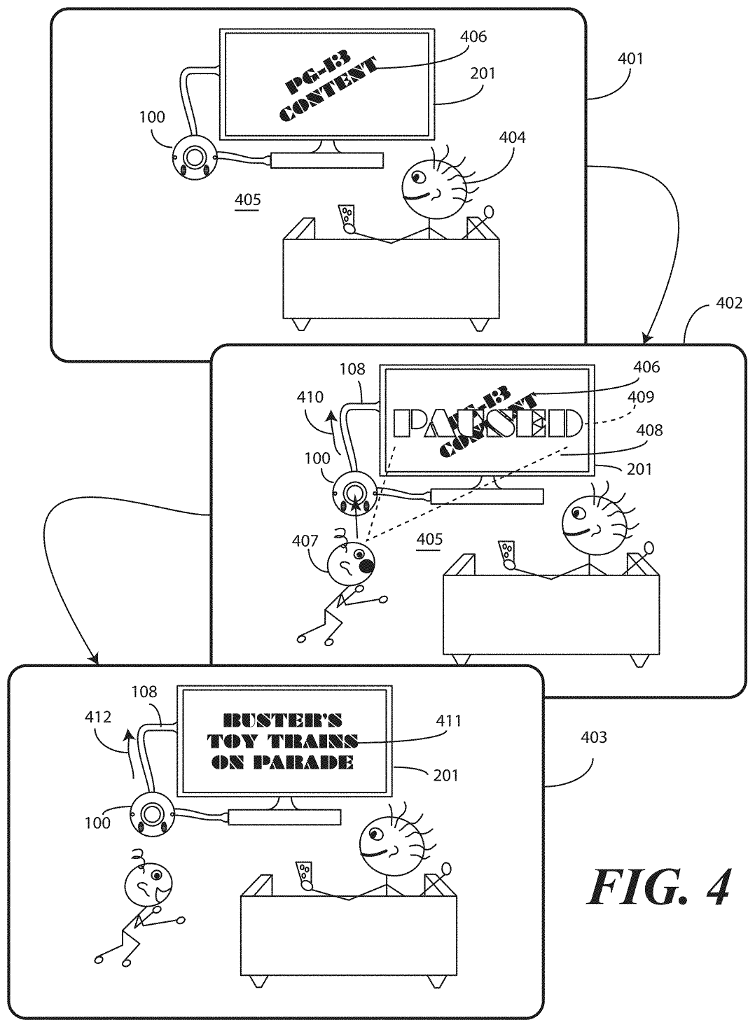

The method 300 of FIG. 3 is shown in action in FIG. 4. Turning now to FIG. 4, at step 401 an interface accessory 100 configured in accordance with one or more embodiments of the disclosure is coupled to a media consumption device 201, shown here as a television monitor. An adult 404 is seated on a sofa within a predefined media consumption environment 405, holding a remote control, and is enjoying a content offering 406, which in this example a “buddy comedy” movie. In this example, the buddy comedy includes several jokes featuring mature situations. For this reason, the content offering 406 has been rated PG-13.

At step 402, a minor 407 enters the predefined media consumption environment 405. The interface accessory 100 detects not only this entry, but also identifies, with one or more sensors in response to the entry detection, at least one personal characteristic corresponding to the minor 407. In this illustration, the personal characteristic is that the minor 407 is indeed a minor. The interface accessory 100 can determine these factors in any of the various ways described above with reference to FIG. 1. For example, an imager (122) may capture images of the minor 407 and perform facial recognition to identify the minor 407. A depth imager (123) can capture depth scans to identify the minor 407. The thermal sensor (124) or proximity sensor or detectors (125) can detect presence by detecting thermal emissions or infrared emissions, and so forth. Since the various ways of detecting and/or identifying persons entering the predefined media consumption environment 405, as well as detecting the personal characteristics corresponding to these persons, were described above with reference to FIG. 1, they will not be repeated in the descriptions of the use cases and methods of the subsequent figures in the interest of brevity.

In this illustration the interface accessory 100 also detects the minor's gaze 408 toward the display of the media consumption device 201. Since the minor 407 should not be exposed to mature content, the interface accessory 100 delivers a control signal 410 to an output connector 108 of the interface accessory 100, with the control signal 410 altering a content presentation characteristic of the content offering 409 being presented by the media consumption device 201 when the output connector 108 is coupled to the media consumption device 201. In this example, the control signal 410 causes the presentation of the content offering 409 to pause 409.

As noted above, in some embodiments, this pause 409 of the presentation of the content offering 406 could continue as long as the minor 407 is within the predefined media consumption environment 405. However, in some embodiments, the interface accessory 100 can instead change the content offering 410 to another content offering 411 that is “kid friendly.” In this example, the interface accessory 100 delivers another control signal 412 to the output connector 108 of the interface accessory 100 at step 403. In one or more embodiments, the second control signal 412 again alter a content presentation characteristic of content being presented by the media consumption device 201 when the output connector 108 is coupled to the media consumption device 201. At step 403, the second control signal 412 causes another content offering 411, which is Buster's Toy Trains On Parade and is kid friendly, to be presented on the media consumption device 201. Thus, as shown and described in FIG. 4, the interface accessory 100 detected a minor 407 entering a predefined media consumption environment, identified that the minor 407 was a minor, determined that the minor 407 was gazing toward the media consumption device 201, and then first paused the buddy comedy movie, and then switched the buddy comedy movie to the kid-friendly show, thereby sparing the minor 407 from hearing off-color jokes.

Advantageously, as depicted in FIG. 3 and illustrated in FIG. 4, embodiments of the disclosure provide an interface accessory 100 that includes one or more sensors, one or more processors operable with the one or more sensors, and an output connector 108 suitable for mechanically and electrically coupling the interface accessory to a media consumption device 201 such as a television screen or other similar monitor. In one or more embodiments, the one or more sensors monitor a predefined media consumption environment 405 about the interface accessory 100. As one or more persons enter, are in, or exit the predefined media consumption environment 405, the one or more processors deliver control signals 410,412 to the media consumption device 201.

This “alteration” of the content occurs, in one or more embodiments, as a function of one or more personal characteristics corresponding to the one or more persons who are in the predefined media consumption environment 405. In the example of FIG. 4, when a person 404 is watching adult-rated content and a minor 407 enters the predefined media consumption environment 405, the one or more processors may deliver a control signal 410 to pause 409 the movie or change it to child-friendly content 411, and so forth.

Advantageously, the interface accessory and corresponding methods and systems provide users with a live and seamless process to enhance their media consumption environment. By including sensors such as an imager or camera in the interface accessory 100, along with facial recognition or other biometric recognition capabilities, the interface accessory 100 can identify who is consuming content and can deliver control signals 410,412 to the media consumption device 201 to alter the content so that it is optimized for all users.

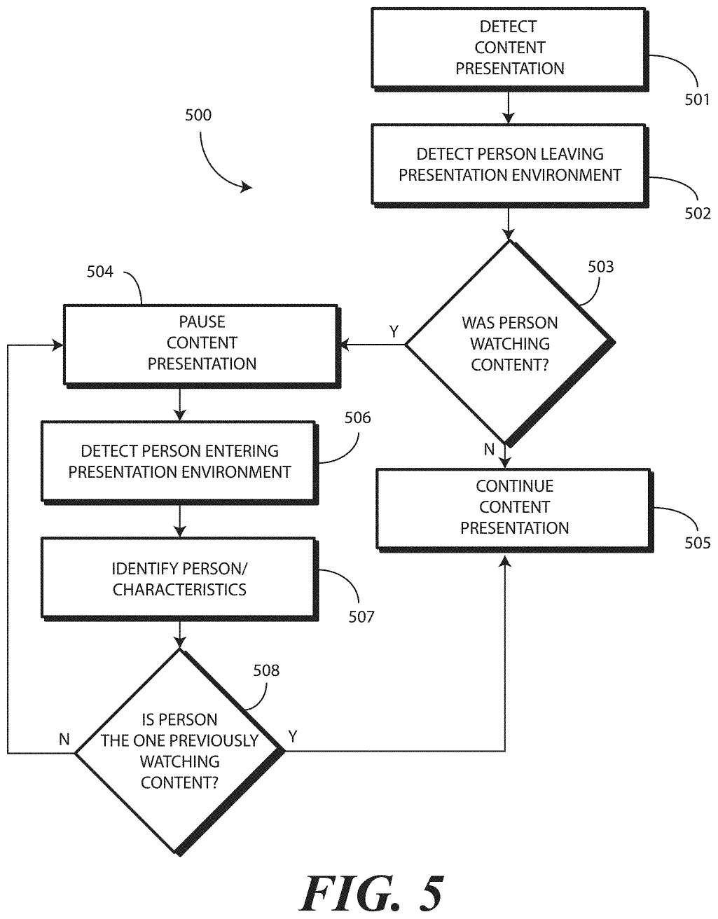

Turning now to FIG. 5, illustrated therein is another method 500 in accordance with one or more embodiments of the disclosure. At step 501, an interface accessory detects a content presentation occurring at a media consumption device. Illustrating by example, the interface accessory may detect that a college football game is being presented on the display of a television monitor. This is an example only, as other content offerings will be obvious to those of ordinary skill in the art having the benefit of this disclosure. In one or more embodiments, step 501 also includes detecting, with one or more sensors of the interface accessory, one or more persons being situated within a predefined media consumption environment of a media consumption device.

At step 502, the method 500 detects at least one person of the one or more persons detected at step 501 exiting the predefined media consumption environment. For instance, a person watching a college football game may need to step out of the predefined media consumption environment to use the restroom. Alternatively, the person may need to exit the predefined media consumption environment to answer the door, a telephone call, or simply to grab a snack. Other reasons for the person to leave the predefined media consumption environment will be obvious to those of ordinary skill in the art having the benefit of this disclosure.

At decision 503, the method optionally determines whether the person exiting the predefined media consumption environment was watching the college football game. As described above, the interface accessory can determine whether the person leaving the predefined media consumption environment was previously gazing toward the media consumption device by detecting their gaze cone. Embodiments of the disclosure contemplate that if a person exiting the predefined media consumption environment were previously reading a book, they would have no interest in the college football game. By contrast, if a person exiting the predefined media consumption environment had previously been gazing toward the television monitor (gaze cone detection), yelling at the referees (voice identification/detection), or jumping up and down when the crowd made loud noises (audio/image identification/detection), then they may be passionate about one of the two teams. Accordingly, optional decision 503 determines whether the person exiting the predefined media consumption environment was previously watching the content.

In one or more embodiments, where a person is detected leaving the predefined media consumption environment at decision 503, and optionally was identified as previously watching the content offering at decision 503, the method 500 delivers, with one or more processors of an interface accessory, another control signal to the output connector at step 504 causing the presentation of the content on the media consumption device to pause. Continuing the example of the college football game, step 504 would therefore cause the college football game to pause while the person was outside the predefined media consumption environment. Advantageously, this step 504 allows the user to run to the restroom without missing a minute of the action.

At step 506, the method 500 detects, with one or more sensors of the interface accessory, a person entering predefined media consumption environment. At step 507, the method 500 identifies, with the one or more sensors of the interface accessory and in response to detecting the person entering the predefined media consumption environment, at least one personal characteristic corresponding to the person entering the predefined media consumption environment. Decision 508 then determines whether the person entering the predefined media consumption environment is the same person that was detected exiting the predefined media consumption environment at step 502.

In one or more embodiments, where a person is detected entering the predefined media consumption environment at step 506 is identified as previously watching the content offering at decision 508, the method 500 delivers, with one or more processors of an interface accessory, another control signal to the output connector at step 505 causing the presentation of the content on the media consumption device to continue. In the example of the college football game, step 505 would therefore cause the college football game to resume when the person returns to predefined media consumption environment. Advantageously, this step 504 allows the user to pick up the game right where they left off when they left the predefined media consumption environment.

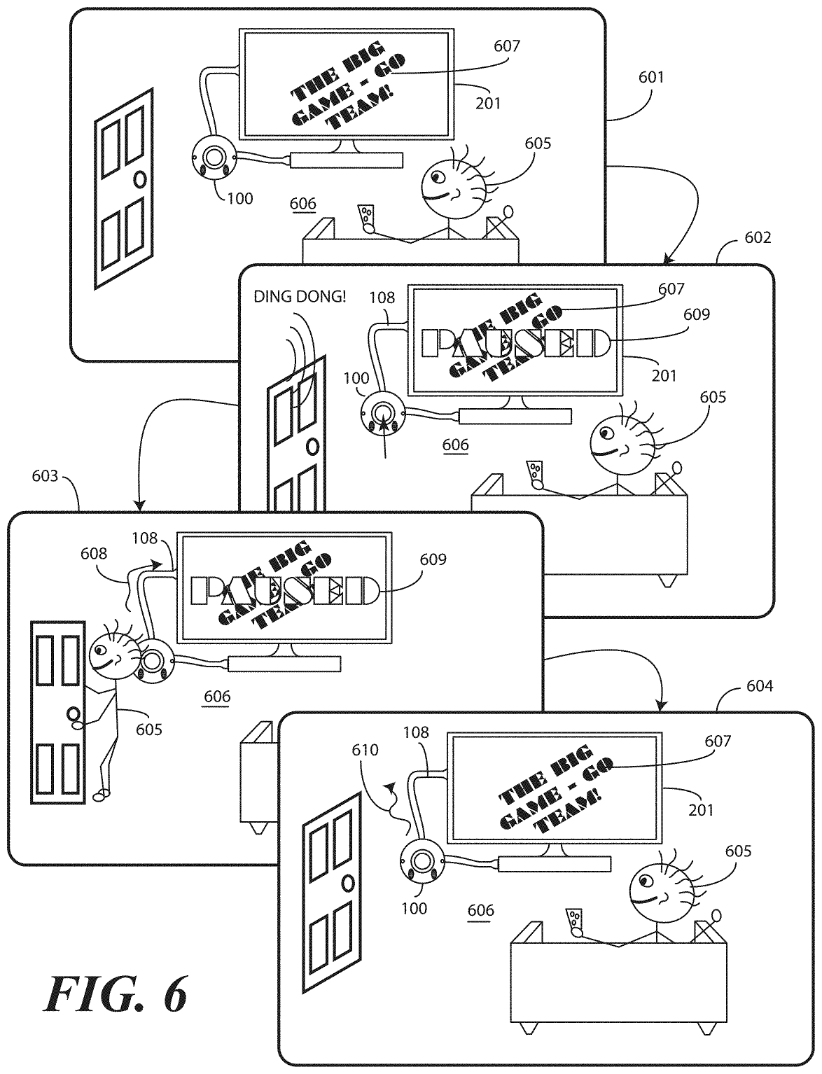

The method 500 of FIG. 5 is illustrated in FIG. 6. Turning now to FIG. 6, at step 601 an interface accessory 100 configured in accordance with one or more embodiments of the disclosure is coupled to a media consumption device 201, shown here as a television monitor. A person 605 is seated on a sofa within a predefined media consumption environment 606. The person 605 is watching a college football game 607.

At step 602, a visitor arrives at the door and rings the doorbell. As will be described below with reference to subsequent figures, in one or more embodiments the sensors of the interface accessory 100 are capable of detecting the doorbell as a predefined environmental characteristic. Where this is detected, one or more control circuits of the interface accessory 100 may deliver control signals to the output connector 108 of the interface accessory 100 to alter a presentation characteristic of the media consumption device 201 in various ways. However, in this example, the sensors of the interface accessory 100 are also monitoring the presence of the person in the predefined media consumption environment 606.

At step 603, these sensors detect the person 605 exiting the predefined media consumption environment 606 to answer the door. This constitutes further an action of at least one person of the one or more persons in the predefined media consumption environment precluding at least one person from consuming content from the media consumption device 201.

In one or more embodiments, when this occurs the interface accessory 100 delivers a control signal 608 to the output connector 108 of the interface accessory 100. This control signal 608 alters a content presentation characteristic of the college football game 607 being presented by the media consumption device 201 when the output connector 108 is coupled to the media consumption device 201. In this example, the control signal 608 causes the presentation of the college football game 607 to pause 609. In one or more embodiments this pause 609 of the college football game 607 continues as long as the person 605 is outside the predefined media consumption environment 606.

At step 604, the sensors of the interface accessory 100 detect the person 605 reentering the predefined media consumption environment 606. In one or more embodiments, when this occurs the interface accessory 100 delivers another control signal 610 to the output connector 108 of the interface accessory 100 at step 604. In one or more embodiments, this control signal 610 again alters a content presentation characteristic of content being presented by the media consumption device 201 when the output connector 108 is coupled to the media consumption device 201. At step 604, this control signal 610 causes the college football game 607 to resume playing. Advantageously, this step 604 allows the user to pick up the game right where they left off when they left the predefined media consumption environment 606.

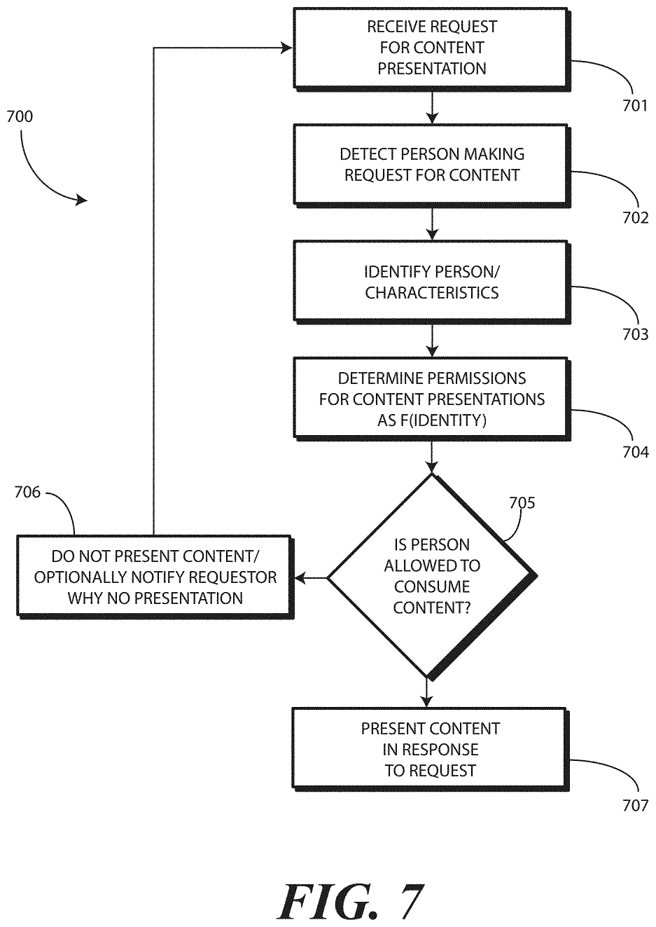

Turning now to FIG. 7, illustrated therein is yet another method 700 for an interface accessory configured in accordance with one or more embodiments of the disclosure. In one or more embodiments, the interface accessory grants different levels of access to content as a function of which people are within the predefined media consumption environment. Illustrating by example, in one or more embodiments the one or more sensors of the interface accessory can detect which persons within the predefined media consumption environment are looking at the media consumption device, as well as identify them by facial recognition or other passive biometric identification techniques, thereby determining which people are in a room, whether they are watching the media consumption device, and who they are. If one was a minor, for example, and was trying to access a streaming media service, that minor may only be able to stream kid-friendly movies, and so forth. One illustrative method 700 for doing this is shown in FIG. 7.

Beginning at step 701, the method 700 receives a request for a content offering to be presented. Illustrating by example, a person may use a remote control to send a signal to a media reception device, the interface accessory, and/or the media consumption device requesting that a particular television show be presented on the media consumption device.

At step 702, the method 700 monitors, using one or more sensors of the interface accessory, any persons within a predefined media consumption environment about the media consumption device. Accordingly, at step 702 the one or more sensors detect the person making the request for the content as described above with reference to FIG. 1.

Step 702 can be performed in various ways. If only one person is within the predefined media consumption environment, that person will be detected as requesting the content. However, where multiple people are within the environment, the person requesting the content can be identified by determining, for example, from one or more sensors whether persons within the predefined media consumption environment are gazing toward the media consumption device while either carrying a remote control or otherwise attempting to control the media consumption device with voice commands.

At step 703, the method 700 identifies one or more personal characteristics corresponding to the person requesting the content at step 701. These personal characteristics can include whether the person is a minor, what content offerings the person typically consumes, when they consume the content offerings, with whom they consume the content offerings, and so forth. Other personal characteristics corresponding to the person requesting the content will be obvious to those of ordinary skill in the art having the benefit of this disclosure.

In one or more embodiments, when such activity is detected, in one or more embodiments the interface accessory grants different levels of access to content based upon the identification of the person within the predefined media consumption environment who is carrying the remote or otherwise attempting to control the media consumption device. Illustrating by example, at step 704 the method 700 determines what permissions are associated with content offerings as a function of the personal characteristics identified at step 703. For instance, where the person is a minor, they may not be allowed to watch content offerings with adult content. Which content offerings are available for consumption, based upon the personal characteristics corresponding to the person requesting the content, is determined at decision 705. If the person is allowed to see all content offerings, the method 700 proceeds to step 707 where the requested content offering is provided. By contrast, if the person is not allowed to see some content offerings, the method 700 moves to step 706, where a control signal is delivered from the interface accessory restricting which content offerings are available for consumption at the media consumption device. In one or more embodiments, step 706 can further include the presentation of a message indicating either that some content offerings are unavailable or why the content offerings are not available as well.

Again illustrating by example, if the person requesting the content, detected at step 702, is identified as a minor at step 703, and that minor is not allowed to see certain content offerings as determined at step 704 and decision 705 working together, at step 706 the method delivers a control signal to an output connector of the interface accessory restricting which content offerings are available for consumption at the media consumption device. Thus, a minor accessing a streaming movie service with the remote control who is looking at the media consumption device while doing so as they search or scroll or navigate will find that certain movies are not selectable, and that only child-friendly movies are capable of being selected and streamed in accordance with the steps set forth in FIG. 7.

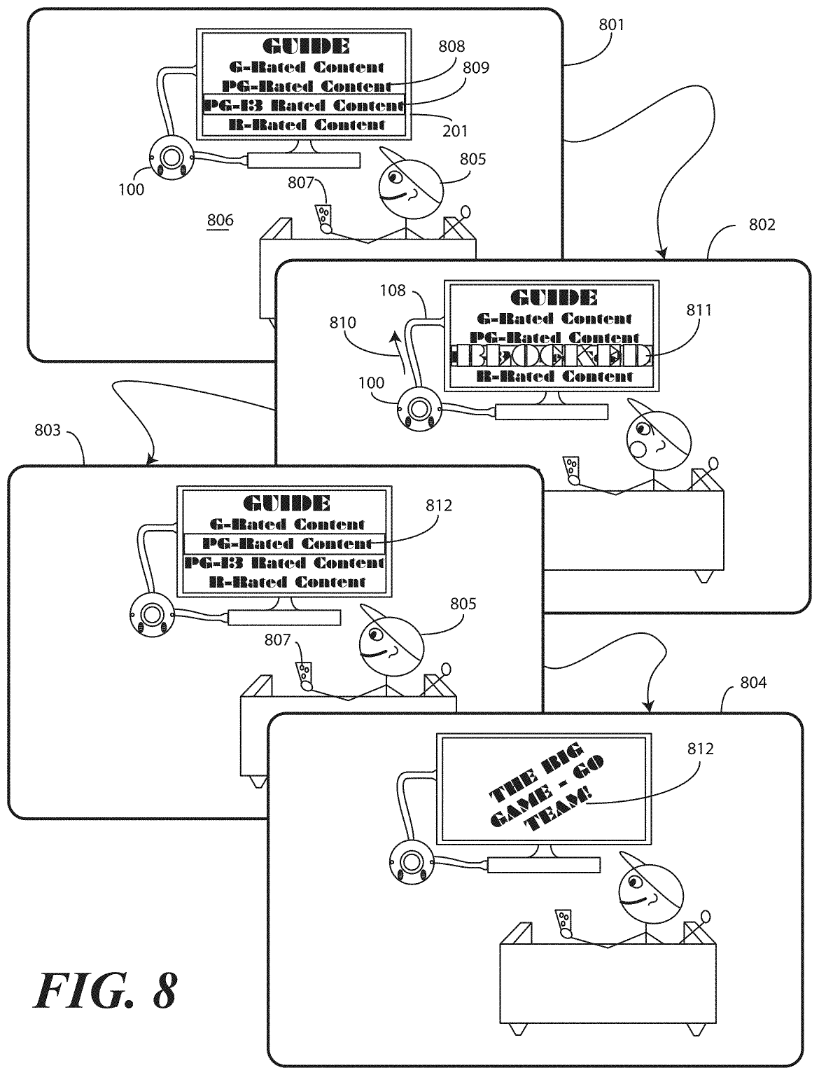

The method of FIG. 7 is shown illustratively in FIG. 8. Turning now to FIG. 8, at step 801 an interface accessory 100 configured in accordance with one or more embodiments of the disclosure is coupled to a media consumption device 201, shown here as a television monitor. A young person 805 is seated on a sofa within a predefined media consumption environment 806. The young person 805 is requesting content by using a remote control 807 to scroll through a menu 808 on the media consumption device 201. As shown, the young person 805 has selected rated content 809 and is requesting the same using the remote control 807.

At step 801, the one or more sensors of the interface accessory 100 monitor the young person 805 while they are within a predefined media consumption environment 806 about the media consumption device 201. Accordingly, the one or more sensors detect that the young person 805 making the request for the rated content 809. In this illustrative embodiment, the young person 605 is holding the remote control 807 and is gazing at the media consumption device 201, each of which is detected by the sensors of the interface accessory 100. Thus, the interface accessory 100 concludes that the young person 605 is requesting the rated content 809.

As described above with reference to FIG. 7, the one or more processors of the interface accessory 100 then identify one or more personal characteristics corresponding to the young person 805. In this illustration, since the young person 805 is young, one personal characteristic is the fact that the young person 805 is young. Other personal characteristics corresponding to the person requesting the content will be obvious to those of ordinary skill in the art having the benefit of this disclosure.

The one or more processors of the interface accessory then determine what permissions are associated with content offerings as a function of the personal characteristics identified. Since the young person 805 is young, in this illustration he is not allowed to watch content offerings with adult content. As such, at step 802 the interface accessory 100 delivers a control signal 810 restricting which content offerings are available for consumption at the media consumption device 201. In this illustration, the interface accessory 100 causes the presentation of a message 811 indicating either that some content offerings are unavailable.

Since the originally requested content offering 809 originally requested at step 801 is not allowed for consumption, at step 803 the young person 805 uses the remote control 807 to navigate to a content offering 812 he is permitted to see. When this is selected, the content offering 812 is presented on the media consumption device 201 at step 804.

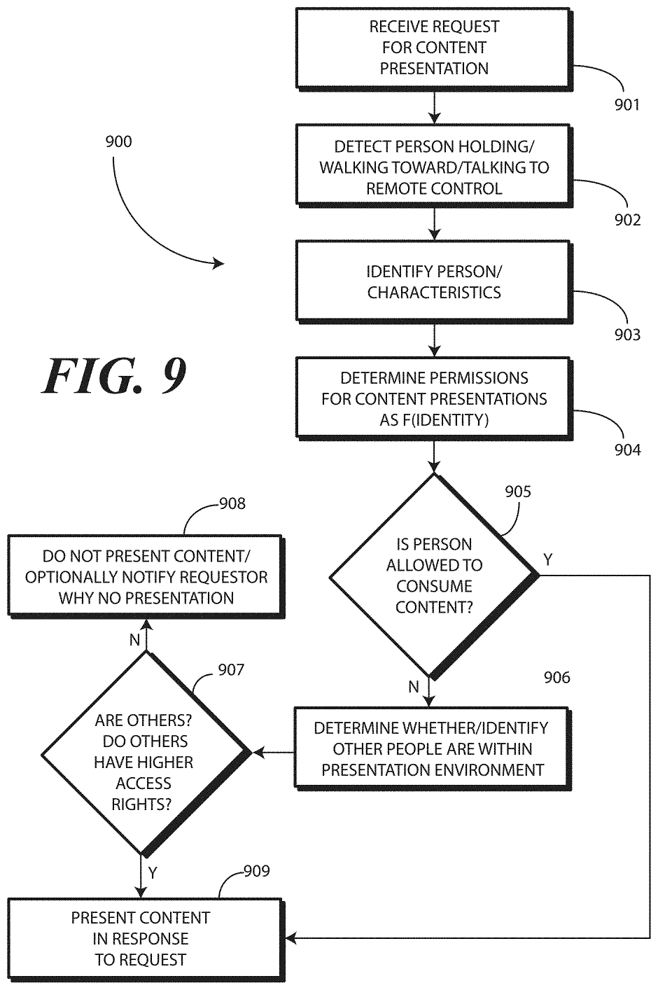

Turning now to FIG. 9, illustrated therein is another method 900 configured in accordance with one or more embodiments of the disclosure. In one or more embodiments, the interface accessory determines, from its one or more sensors, whether persons within the predefined media consumption environment are gazing toward the media consumption device while either carrying a remote control or attempting to control the media consumption device with voice commands. When such activity is detected, in one or more embodiments the interface accessory bypasses permission access levels as a function of the captured identification of the person within the predefined media consumption environment who is carrying the remote or otherwise attempting to control the media consumption device while other persons are also within the predefined media consumption environment.

Thus, for example, when a minor is accessing a streaming movie service with the remote control while looking at the media consumption device and searching or scrolling or navigating, but while an adult or parent is also within the predefined media consumption environment and gazing at the media consumption device, access will be granted based upon the adult or parent rather than the minor. Advantageously, this will expand the minor's access to content by bypassing the minor's permission restrictions and instead offering content selections commensurate with the parent's permissions. One illustrative method 900 for doing this is shown in FIG. 9.

Beginning at step 901, the method 900 receives a request for a content offering to be presented. At step 902, the method 900 monitors, using one or more sensors of the interface accessory, any persons within a predefined media consumption environment about the media consumption device.

In one or more embodiments, step 902 comprises identifying a person making the request for content by identifying a person who is holding a remote control. In another embodiment, step 902 comprises identifying a person walking toward a media consumption device. In another embodiment, step 902 comprises identifying a person speaking a command to a media consumption device. In another embodiment, step 902 comprises identifying a person holding companion device, such as a fob, smart watch, or smartphone. Regardless of the technique use, in one or more embodiments step 902 includes the one or more sensors detect the person making the request for the content as described above with reference to FIG. 1.

At step 903, the method 900 identifies one or more personal characteristics corresponding to the person requesting the content at step 901. At step 904 the method 900 determines what permissions are associated with content offerings as a function of the personal characteristics identified at step 903. Which content offerings are available for consumption, based upon the personal characteristics corresponding to the person requesting the content, is determined at decision 905. If the person is allowed to see all content offerings, the method 900 proceeds to step 909 where the requested content offering is provided.

In FIGS. 7-8 above, if the person was not allowed to see some content offerings, a control signal is delivered from the interface accessory restricting which content offerings are available for consumption at the media consumption device. In FIG. 9, the method 900 performs an additional check to see if any other person situated within the predefined media consumption environment has higher-level privileges at decision 907. For example, if a parent is in the room with a minor, as determined at decision 907, and the there are no access restrictions associated with the parent, the method 900 moves to step 909 where the requested content offering is provided. Embodiments of the disclosure contemplate that the parent will exercise the necessary parental controls regarding which content can be consumed, and therefore the interface accessory need not do so.

However, if no person with higher permission credentials is within the predefined media consumption environment, the method 900 can move to step 908 where the available content offerings are restricted as previously described. In one or more embodiments, step 908 can further include the presentation of a message indicating either that some content offerings are unavailable or why the content offerings are not available as well. Advantageously, the method 900 of FIG. 9 determines at decision 907, whether at least two persons are within the predefined media consumption environment, and if so, whether one of the persons has associated therewith a personal characteristic of being an adult. Where this is the case, step 909 ceases any restriction that may have occurred limiting which content offerings are available for consumption at the media consumption device.

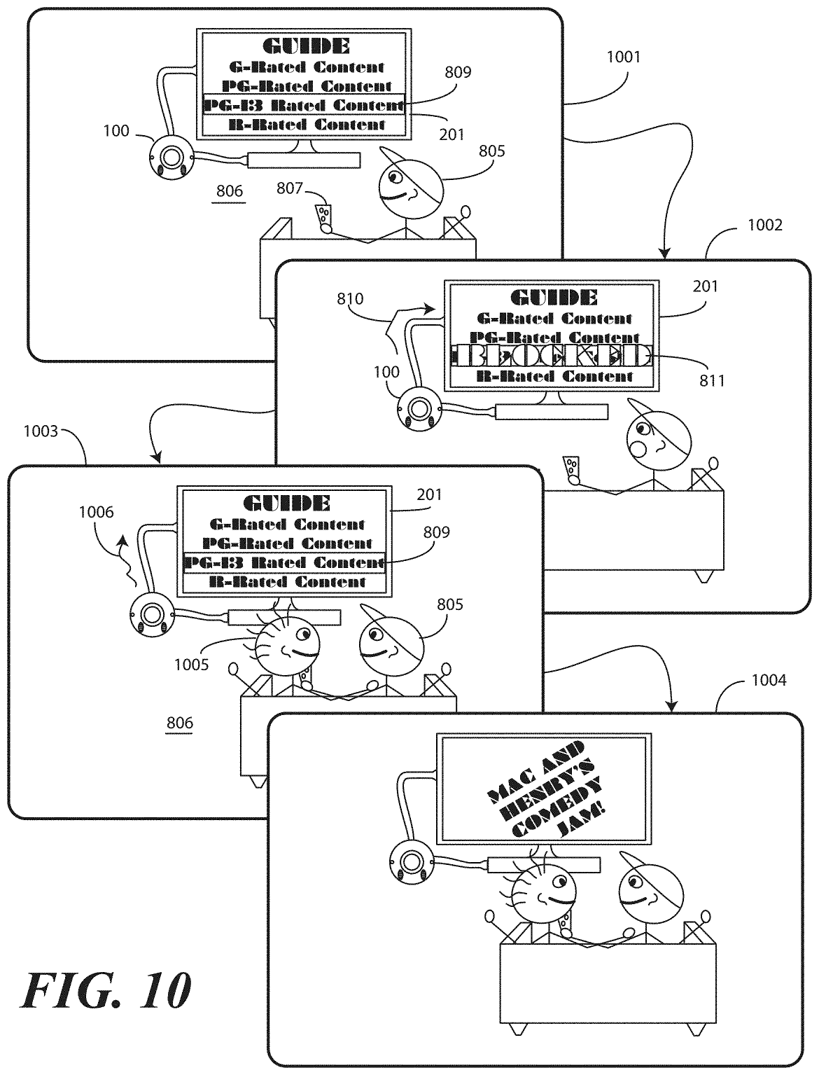

The method of FIG. 9 is shown illustratively in FIG. 10. Turning now to FIG. 10, at step 1001 an interface accessory 100 configured in accordance with one or more embodiments of the disclosure is coupled to a media consumption device 201, shown here as a television monitor. A young person 805 is seated on a sofa within a predefined media consumption environment 806. The young person 805 is requesting content by using a remote control 807 to scroll through a menu 808 on the media consumption device 201. As shown, the young person 805 has selected rated content 809 and is requesting the same using the remote control 807.

At step 1001, the one or more sensors of the interface accessory 100 monitor the young person 805 while they are within a predefined media consumption environment 806 about the media consumption device 201. Accordingly, the one or more sensors detect that the young person 805 making the request for the rated content 809. In this illustrative embodiment, the young person 605 is holding the remote control 807 and is gazing at the media consumption device 201, each of which is detected by the sensors of the interface accessory 100. Thus, the interface accessory 100 concludes that the young person 605 is requesting the rated content 809.

The one or more processors of the interface accessory 100 then identify one or more personal characteristics corresponding to the young person 805. The one or more processors of the interface accessory 100 then determine what permissions are associated with content offerings as a function of the personal characteristics identified. Since the young person 805 is young, in this illustration he is not allowed to watch content offerings with adult content. As such, at step 1002 the interface accessory 100 delivers a control signal 810 restricting which content offerings are available for consumption at the media consumption device 201. In this illustration, the interface accessory 100 causes the presentation of a message 811 indicating either that some content offerings are unavailable.

At step 803, the interface accessory 100 detects another person 1005 entering the predefined media consumption environment 806. The one or more processors of the interface accessory 100 then identify one or more personal characteristics corresponding to the person 1005 entering the predefined media consumption environment 806. In this illustration, the one or more personal characteristics comprise at least the fact that the person is an adult.

The one or more processors of the interface accessory 100 then determine what permissions are associated with content offerings as a function of the personal characteristics identified. Since the other person 1005 is an adult, in this illustration he is allowed to watch content offerings with adult content. As such, at step 1004 the interface accessory 100 delivers another control signal 1006 removing the restriction limiting which content offerings are available for consumption at the media consumption device 201. As such, the message 811 indicating either that some content offerings are unavailable is removed. The young person then selects the rated content offering 809, which begins playing at step 1004.

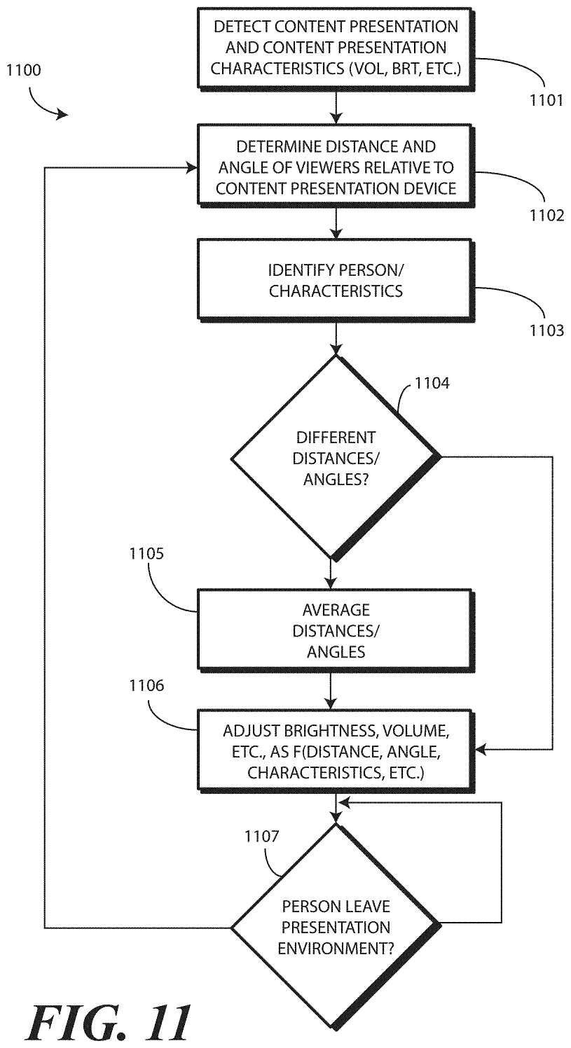

Turning now to FIG. 11, illustrated therein is another method in accordance with one or more embodiments of the disclosure. In one or more embodiments, an interface accessory configured in accordance with embodiments of the disclosure can make adjustments to settings of a media consumption device as well. For example, in one or more embodiments the interface accessory includes an imager and a depth scanner, as described above with reference to FIG. 1. These sensors can function to determine angles of persons situated within a predefined media consumption environment relative to the media consumption device, as well as distances of each person from the media consumption device.

One or more processors of the interface accessory can then generate control signals as a function of these distances, angles, and/or locations, and can deliver them to an output connector of the interface accessory. The control signals can then adjust control setting such as brightness level output by the media consumption device, volume level output by the media consumption device, and so forth, as a function of the different distances, angles, and/or locations of the persons relative to the media consumption device when the output connector is coupled to the media consumption device.

Illustrating by example, the one or more processors may average the different distances relative to the media consumption device of each person and then adjust the volume such that a person sitting the average distance from the media consumption device would experience an optimal audio experience. Alternatively, the control signals may adjust the audio such that the person closest to the media consumption device would not be overloaded by the audio output, thereby ensuring that they have an enjoyable audio experience, and so forth.

In one or more embodiments, is a person close to the media consumption device and a person far from the media consumption device are watching a movie at the same time, the volume level output of the media consumption device can be adjusted as a function of the average distance so that the close person is not overwhelmed by the sound level, but that the person far from the electronic device can still hear. That means the close person will experience higher than normal levels to accommodate the far person. A method 1100 for performing these functions is shown in FIG. 11.

Beginning at step 1101, the method 1100 detects that a content offering is being presented by a media consumption device. At step 1101, the method further determines one or more control settings for the media consumption device. These control settings can include brightness level output by the media consumption device, volume level output by the media consumption device, whether the audio output is being directed into the air by loudspeakers or to headphones by a wired or wireless connection, and so forth. Other control settings will be obvious to those of ordinary skill in the art having the benefit of this disclosure.

At step 1102, the method 1100 identifies, with one or more sensors of an interface accessory, one or more persons being within a predefined media consumption environment about a media consumption device. Since the sensors of the interface accessory are monitoring the one or more persons within the predefined media consumption environment about the media consumption device, step 1103 can also include determining one or more personal characteristics corresponding to the one or more persons. In this illustration, the personal characteristics comprise the one or more persons situating themselves at different distances relative to the media consumption device.

At decision 1104, the method 1100 determines whether the one or more persons are at different distances, locations, and/or angles from the media consumption device. For example, decision 1104 may determine that a first person is a first distance from the media consumption device and at least a second person is a second distance from the media consumption device. Similarly, decision 1104 may determine that a first person is directly in front of the media consumption device, while another person is offset from an axis normal to a display of the media consumption device. Decision 1104 may determine that a first person is situated at one location within the predefined media consumption environment, while another is situated at another location within the predefined media consumption environment, and so forth.

At step 1105, the method 1100 can process the differences determined at decision 1104. For example, when a first person is a first distance from the media consumption device and at least a second person is a second distance from the media consumption device, step 1105 can include averaging, by one or more processors of an interface accessory, the different distances relative to the media consumption device for each person of the one or more persons. The same type of averaging can be done for angles, positions, or other measurable characteristics associated with the persons situated within the predefined media consumption environment.

At step 1106, the method 1100 can include delivering, with the one or more processors of the interface accessory, a control signal to an output connector of the interface accessory. In one embodiment, the control signal adjusts one or more of a volume level output by the media consumption device, a brightness level output by the media consumption device, or other output settings of the media consumption device as a function of the different distances relative to the media consumption device when the output connector is coupled to the media consumption device. The control signal thus causes adjustment of a volume level output by the media consumption device to optimize the volume level output for the at least a first person and the at least a second person. Advantageously, using volume as an example, the method 1100 can average the distances that the persons are from the media consumption device and adjust the volume such that each person has an optimal aural experience.

At optional decision 1107, the method 1100 can detect one person exiting the predefined media consumption environment. In one or more embodiments, if the person farthest from the media consumption device decides to leave the media consumption environment, such as to get a snack or answer the phone or door, the sensors of the interface accessory detect this action. When this occurs, as determined by decision 1107, the one or more processors of the interface accessory can then generate another control signal to bring down the volume level output so that the person closer to the media consumption device can experience a lower, more comfortable sound level by returning to step 1102 and repeating the steps 1102 and 1103, and decision 1104, as well as decision as 1105 and 1106. Thus, the method 1100 of FIG. 11 can also include determining, with the one or more sensors of the interface accessory at decision 1107, at least one person of the one or more persons exiting the predefined media consumption environment and delivering, with the one or more processors once the steps and decisions between step 1102 and step 1106 are repeated, another control signal to the output connector causing another adjustment of the volume level output by the media consumption device as a function of the new distances of the remaining people within the predefined media consumption environment.

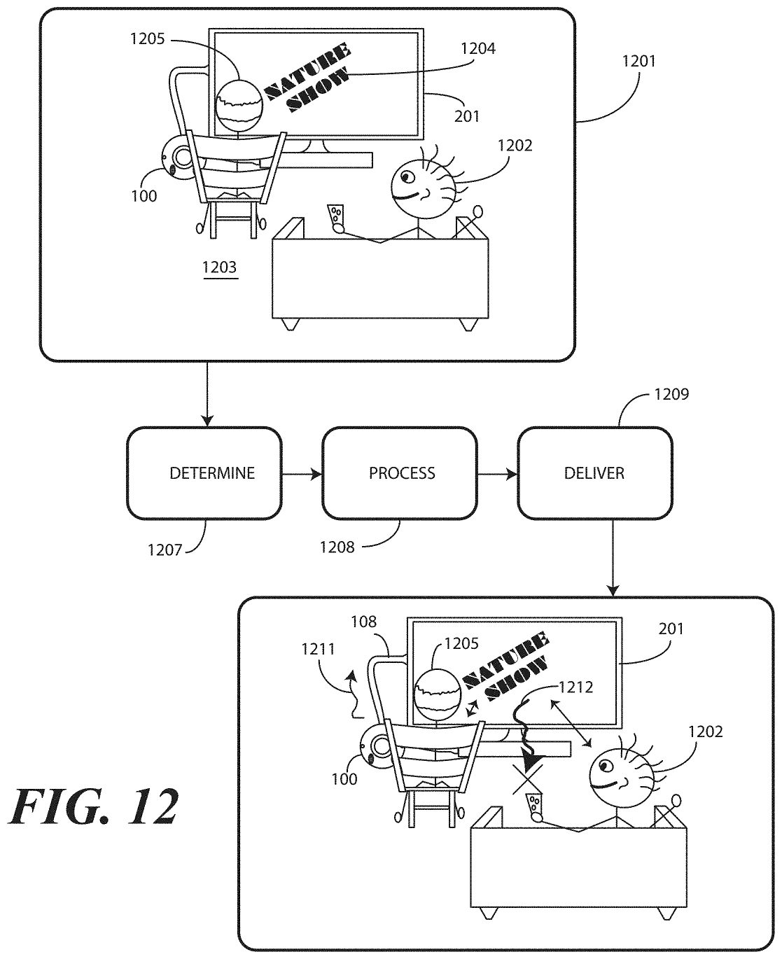

The steps of method 1100 are illustrated in FIG. 12. Turning now to FIG. 12, at step 1201 an interface accessory 100 configured in accordance with one or more embodiments of the disclosure is coupled to a media consumption device 201. A person 1202 is seated on a sofa a first distance away from the media consumption device 201 within a predefined media consumption environment 1203. The person 1202 is holding a remote control and enjoying a content offering 1204.

At the same time, an older person 1205 is sitting in a chair 1206 a second distance from the media consumption device 201 within the predefined media consumption environment 1203. Since the older person 1205 has weakened eyesight, he must sit closer to the media consumption device 201 than person 1202. However, they both enjoy the content offering 1204, as well as watching it together.

At step 1207, the one or more sensors of the interface accessory 100 identify the person 1202 and the older person 1205 being within the predefined media consumption environment 1203. As described above with reference to FIG. 11, step 1207 can also include the interface accessory 100 determining that the person 1202 and the older person 1205 have situated themselves at different distances relative to the media consumption device 201, as well as what the different distances, locations, and/or angles from the media consumption device 201 are.

At step 1208, the interface accessory 100 can process the differences determined at step 1207. In one embodiment, this includes averaging the different distances relative to the media consumption device 201 for the person 1202 and the older person 1205. As noted above, the same type of averaging can be done for angles, positions, or other measurable characteristics associated with the persons situated within the predefined media consumption environment.

At step 1209, one or more processors of the interface accessory 100 deliver a control signal 1211 (shown in step 1210) to an output connector 108 of the interface accessory 100 (also shown in step 1210). In this example, the control signal 1211 adjusts the volume level 1212 output by the media consumption device 201 as a function of the different distances relative to the media consumption device 201 when the output connector 108 is coupled to the media consumption device 201. The control signal 1211 thus causes adjustment of a volume level 1212 output by the media consumption device 201 to optimize the volume level 1212 output for the person 1202 and the older person 1205. Advantageously, the volume level 1212 output by the media consumption device 201 is averaged such that the person 1202 and the older person 1205 enjoy an optimal aural experience.

In one or more embodiments, if the person 1202 far from the media consumption device 201 decides to leave the predefined media consumption environment 1203, such as to get a snack or answer the phone or door, the sensors of the interface accessory 100 can detect this action. When this occurs, the one or more processors of the interface accessory 100 can then generate another control signal to bring down the volume level output so that the person closer to the media consumption device 201, i.e., the older person 1205, can experience a lower, more comfortable sound level.

It should also be noted that the older person 1205 might have a hearing impairment. In such conditions, step 1208 will include processing the location information to accommodate for this lessened hearing condition. In one or more embodiments, when a person within the predefined media consumption environment 1023 has a hearing impairment or has a lessened hearing condition, the one or more processors can generate a control signal at step 1209 causing adjustment of the volume level 1212 output of the media consumption device 201 to increase the same to compensate for the lessened hearing condition. This adjustment could be applied to any of the embodiments described in FIGS. 3-17.

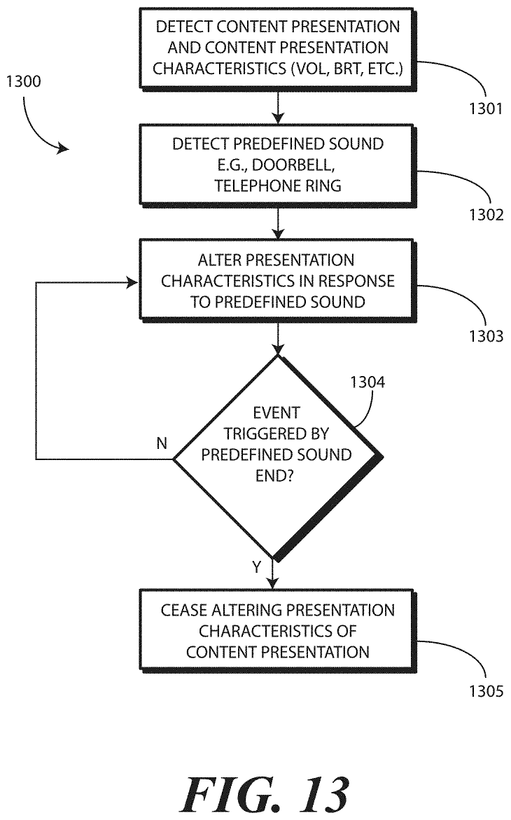

Turning now to FIG. 13, illustrated therein is another method 1300 for an interface accessory configured in accordance with one or more embodiments of the disclosure. As noted above, in one or more embodiments an interface accessory includes audio input devices to detect audio signals identifying predefined situations such as a telephone ringing, a doorbell, a knock at the door, or people engaging in a conversation. In one or more embodiments, the one or more processors can generate, in response to detecting the predefined situation, a control signal causing adjustment of the volume level output of the media consumption device to decrease the during the duration of the predefined situation. Upon detecting a termination of the predefined condition, in one or more embodiments, the one or more processors can generate a control signal causing the volume level output of the media consumption device to return to the level occurring prior to the predefined situation. A method 1300 for doing this is shown in FIG. 13.

Beginning at step 1301, the method 1300 detects that a content offering is being presented by a media consumption device. At step 1301, the method 1300 further determines one or more control settings for the media consumption device. These control settings can include brightness level output by the media consumption device, volume level output by the media consumption device, whether the audio output is being directed into the air by loudspeakers or to headphones by a wired or wireless connection, and so forth. Other control settings will be obvious to those of ordinary skill in the art having the benefit of this disclosure.

At step 1302, the method 1300 detects, with one or more sensors of an interface accessory, at least one environmental characteristic of the predefined media consumption environment. Examples of environmental characteristics include at least one of a doorbell ring, a telephone ring, a door knock, a device command such as “play here,” or the entry into a conversation by at least one person when consuming content. Thus, in one embodiment a microphone may detect a known sound such as a door knock or telephone ring. Other examples of environmental characteristics will be obvious to those of ordinary skill in the art having the benefit of this disclosure.

In one embodiment, the method 1300 delivers, with one or more processors of the interface accessory, a control signal to an output connector of the interface accessory altering a content presentation characteristic of content being presented by the media consumption device when the output connector is coupled to the media consumption device in response to detecting the environmental characteristic at step 1303. Thus, for example, if one or more microphones of the interface accessory detect a knock at the door, the one or more processors of the interface accessory may pause the content presentation, or alternatively reduce the volume of the content presentation, or take another action, so that the person watching the content could go to the door and interact with their visitor.

At decision 1304, the method determines whether the event triggered by the environmental characteristic detected at step 1302 has ended. Illustrating by example, one or more microphones of the interface accessory may detect another environmental characteristic such as the sound of a door shutting, which indicates that the engagement with the visitor has ended. In one or more embodiments, when this occurs the method 1300 includes delivering another control signal to the output connector causing a cessation of the action taken at step 1303. If, for instance, the volume was reduced at step 1303, step 1305 can include returning the volume to its previous level. If the action taken at step 1303 was pausing the presentation of content, step 1305 can include resuming the presentation of the content, and so forth.

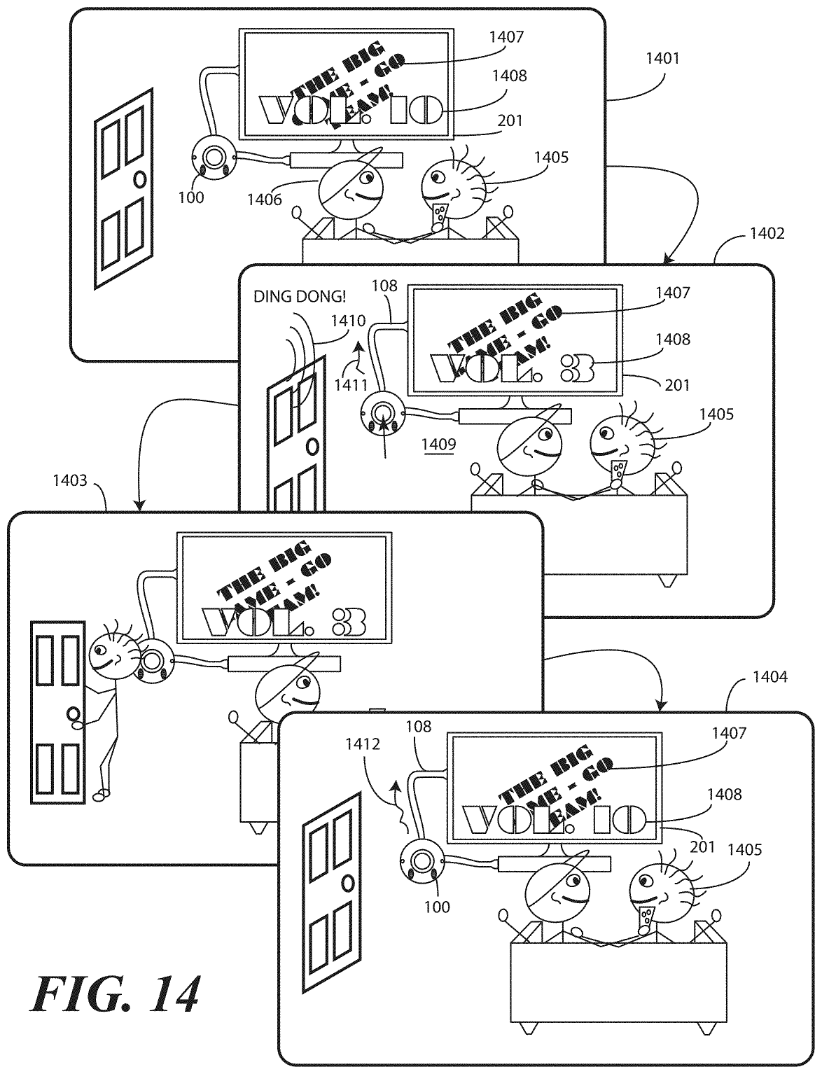

The method 1300 of FIG. 13 is shown illustratively in FIG. 14. Turning now to FIG. 14, and beginning at step 1401, an interface accessory 100 configured in accordance with one or more embodiments of the disclosure is coupled to a media consumption device 201. Two people 1405,1406 are seated on a sofa enjoying a content offering 1407. As shown in step 1401, the volume output level 1408 is set to level ten, as this is the level at which the pair enjoys watching the big game.

At step 1402, the predefined media consumption environment experiences an environmental characteristic 1410, which in this case is a doorbell ring. The interface accessory 100 detects this environmental characteristic 1410. Accordingly, the interface accessory 100 delivers control signals 1411 to the output connector 108 in response to detecting the environmental characteristic 1410. As before, the control signals 1411 altering a content presentation characteristic of the content offering 1407 being presented by the media consumption device 201 as a function of the environmental characteristic 1410 when the output connector 108 is coupled to the media consumption device 201. In this illustration, the control signals 1411 reduce the volume output level 1408 to level three, which is a level low enough for a person 1405 to go to the door and engage with the caller, as show in step 1403.

At step 1404, the person closes the door and returns to the sofa. The interface accessory 100 detects this action as the end of the event triggered by the detection of the environmental characteristic 1410. When that occurs, the interface accessory 100 delivers control signals 1412 to the output connector 108. The control signals 1412 once again alter a content presentation characteristic of the content offering 1407 being presented by the media consumption device 201. In this illustration, the control signals 1412 return the volume output level 1408 to level ten, which is the level at which the pair enjoys watching the big game.

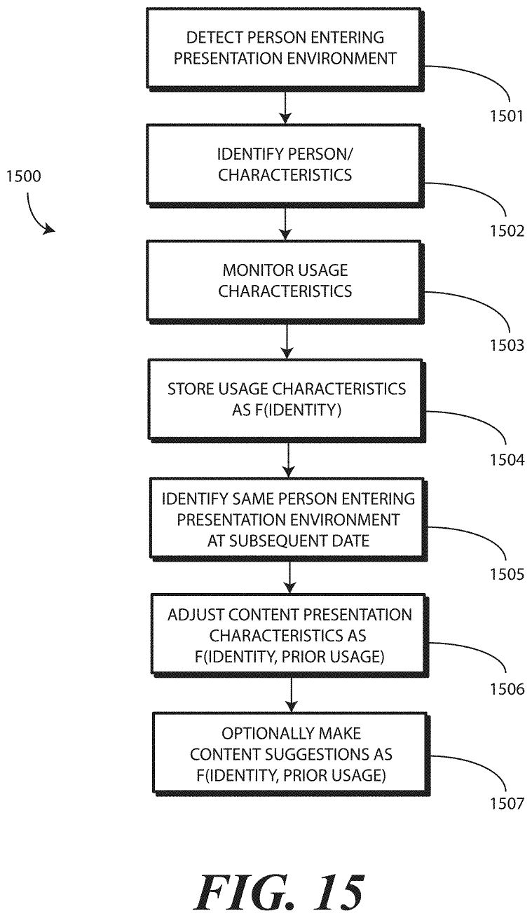

Turning now to FIG. 15, illustrated therein is yet another method 1500 for an interface accessory configured in accordance with one or more embodiments of the disclosure. In one or more embodiments, the one or more processors of the interface accessory include an AI engine that is operable with the various sensors of the interface accessory. The AI engine can be configured via coded instructions to recognize and identify users and their habits, e.g., what content they consume, when they consume this content, who consumes content with them, space features and objects within a media consumption environment that can aid in assessing user location via association instead of triangulation, and so forth. This AI engine can then associate predefined preferences with each person. The AI engine might, for instance, associate media consumption device settings, lighting, loudness, preferred sitting locations, and so forth, with each user. This can be used to deliver control signals to the media consumption device to accommodate these predefined preferences when a particular user when that user enters the predefined media consumption environment.

Moreover, in one or more embodiments the one or more processors of the interface accessory can make content recommendations, filtering and selecting based upon user preferences after identifying a person or persons being within the predefined media consumption environment. In one or more embodiments, the one or more processors of the interface accessory can remember the media consumption habits of a particular user, as well as particular content offerings that an identified person likes. This data can be stored using the AI engine and/or machine learning to help make content recommendations for users and/or automate program selection when a person is identified within the predefined media consumption environment. One illustrative method 1500 for doing this is set forth in FIG. 15.

Beginning at step 1501, the method 1500 detects, with one or more sensors of the interface accessory, a person entering predefined media consumption environment. At step 1502, the method 1500 identifies, with the one or more sensors of the interface accessory and in response to detecting the person entering the predefined media consumption environment, at least one personal characteristic corresponding to the person entering the predefined media consumption environment.

In one or more embodiments, facial recognition, imager scene recognition, voice recognition, depth scan recognition, or other techniques, described above, can be used to identify the at least one personal characteristic at step 1502 and objects in the area, room size, etc. Examples of personal characteristics include the person entering the predefined media consumption environment being a minor, whether the person entering the predefined media consumption environment is gazing at the media consumption device, whether the person entering the predefined media consumption environment is holding a remote control device capable of controlling the media consumption device, whether the person has a lessened eyesight condition, whether the person has a lessened hearing condition, how far the person is from the media consumption device, the angle at which the person is relative to a planar surface or display of the media consumption device, what content preferences the person entering the predefined media consumption environment has, what content the person entering the predefined media consumption environment has watched in the past, when they have watched such content, and so forth. This list is illustrative only, and is not meant to be comprehensive. Numerous other personal characteristics corresponding to persons entering the predefined media consumption environment will be obvious to those of ordinary skill in the art having the benefit of this disclosure.

At step 1503, the method 1500 monitors how the person identified at steps 1501,1502 consumes content. One or more processors of the interface accessory 100 can monitor, for example, content preferences the person entering the predefined media consumption environment has, e.g., whether the person likes sporting events, comedies, or drama movies, what content the person entering the predefined media consumption environment has watched in the past, e.g., the names of movies watched, genres, actors, and so forth, when they have watched such content, with whom they have watched such content, etc.

The characteristics detected at step 1503 can also include preferred user settings corresponding to a media consumption device. For example, they can include preferred volume settings, preferred brightness levels, preferred content playlists, preferred content offering lists, and so forth. Such monitored conditions can be stored in a memory as a function of the person being monitored at step 1504.

At some later time, at step 1505 the method 1500 can identify the same person entering a predefined media consumption environment. When this occurs, at step 1506 the method 1500 can suggest, drawing from these preferences and preferred conditions stored in a memory of the interface accessory, can make suggestions of content consumption or content presentation characteristics as a function of prior usage. For example, step 1506 can include pre-setting a volume level, brightness level, queuing up a particular content offering, returning a partially previously watched content offering to the place where is was previously paused, and so forth. Additionally, content suggestions as a function of previously consumed content can be made at step 1507.

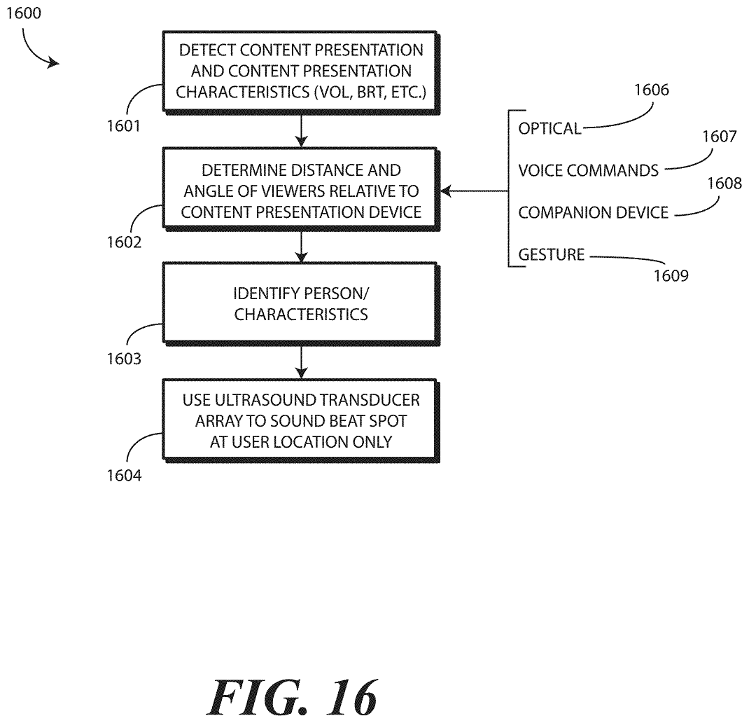

Turning now to FIG. 16, illustrated therein is yet another method 1600 for an interface accessory configured in accordance with one or more embodiments of the disclosure. As noted above with reference to FIG. 1, in one or more embodiments the interface accessory includes ultrasound transducers that allow audio signals to be delivered to specific locations where outputs from the ultrasound transducers intersect. This allows audio to be steered in situations where not everyone within the room or other predefined media consumption environment wants to hear the audio associated with particular content.

Advantageously, when each ultrasound transducer points in a different direction, a particular user can give a command such as speaking the words, “play here.” When this occurs, audio input devices of the interface accessory can receive and assess this audible command. Alternatively, an imager can analyze lip movement from captured images to identify the voice command. Regardless of how the voice command is received, in one or more embodiments the directional output of each ultrasound transducer can be adjusted to point at, and define, a sound “beat spot” at the location where the user uttering the voice command is located. This allows that user to hear audio while others nap, read the paper, knit, crochet, work crossword puzzles, and so forth.

In alternate embodiments, the location at which the directional audio output from the ultrasound transducers intersect can be controlled as a function of the distance of the person nearest the media consumption device, as detected by an imager or other sensor. Additionally, rather than using a voice command such as “play here,” in other embodiments a person can carry a companion device, such as a remote control, a smart watch or fob that can be used as a directional beacon to determine where the intersection of the directional audio output from the ultrasound transducers will occur. As an added feature, in still other embodiments imagers of the interface accessory can capture and detect hand or other gestures from people to determine where the intersection of the directional audio output from the ultrasound transducers will occur. This approach can be advantageous in noisy environments where the integrity of voice commands received by the audio input devices is lower than desirable. Such a method 1600 for doing this is shown in FIG. 16.

At step 1601, the method 1600 detects that a content offering is being presented by a media consumption device. At step 1601, the method 1600 further determines one or more control settings for the media consumption device. These control settings can include brightness level output by the media consumption device, volume level output by the media consumption device, whether the audio output is being directed into the air by loudspeakers or to headphones by a wired or wireless connection, and so forth. As noted above, other control settings will be obvious to those of ordinary skill in the art having the benefit of this disclosure.

At step 1602, the method 1600 identifies, with one or more sensors of an interface accessory, one or more persons being within a predefined media consumption environment about a media consumption device. Since the sensors of the interface accessory are monitoring the one or more persons within the predefined media consumption environment about the media consumption device, step 1603 can also include determining one or more personal characteristics corresponding to the one or more persons. In this illustration, the personal characteristics comprise the one or more persons situating themselves at different distances relative to the media consumption device.

The relationship between the persons in the predefined media consumption environment and the media consumption device in a variety of ways. Illustrating by example, an imager of an interface accessory can detect where people are by optical techniques 1606 such as capturing pictures with a 180-degree field of view imager to detect where the persons are with relation to the media consumption device. A directional microphone or microphone array with beam steering capability can detect voice commands 1607 such as “play here” to determine where persons consuming content are located relative to the media consumption device. As noted above, the location of a companion device 1608, such as a remote control, a smartphone, fob, or other companion device 1608 by wireless or optical signal triangulation or other techniques can be used to determine where persons consuming content are located relative to the media consumption device. An imager or depth imager can detect a person making gestures 1609 to determine where persons consuming content are located relative to the media consumption device as well. Other techniques for determining where persons consuming content are located relative to the media consumption device will be obvious to those of ordinary skill in the art.

Recall from above that an interface accessory configured in accordance with one or more embodiments of the disclosure can be configured with a gaze detector. Specifically, a gaze detector can include sensors for detecting the user's gaze point. The gaze detector can optionally include sensors for detecting the alignment of a user's head in three-dimensional space. Electronic signals can then be processed for computing the direction of user's gaze in three-dimensional space.

The gaze detector can further be configured to detect a gaze cone corresponding to the detected gaze direction, which is a field of view within which the user may easily see without diverting their eyes or head from the detected gaze direction. The gaze detector can be configured to alternately estimate gaze direction by inputting images representing a photograph of a selected area near or around the eyes. Where the interface accessory includes such a gaze detector, step 1602 can further determine whether the various persons, at their various locations, are gazing at the media consumption device.

At step 1603, the method 1600 can optionally identify, with the one or more sensors of the interface accessory, at least one personal characteristic corresponding to the persons situated within the predefined media consumption environment. As noted above, facial recognition, voice recognition, depth scan recognition, or other techniques described above can be used to identify the at least one personal characteristic. These have been previously described and will not be repeated here in the interest of brevity.

Also recall from above, that in one or more embodiments an interface accessory can include one or more ultrasonic transducers of an ultrasonic transducer array to deliver audio signals to specific locations where outputs from the ultrasound transducers intersect. This allows audio to be steered to locations where selected persons are situated within a predefined environment. At step 1604 the method 1600 employs these ultrasonic transducers to direct audio only to those locations where persons who are watching the content are situated. For instance, where at least two persons are within the predefined media consumption environment, the method 1600 can determine a gaze of the one person toward the media consumption device and the other not gazing toward the media consumption device, can cause a cessation of audio output by the media consumption device and a delivery with the ultrasound transducer array of the interface accessory, a beat audio output at the location of the at least one person at step 1604.

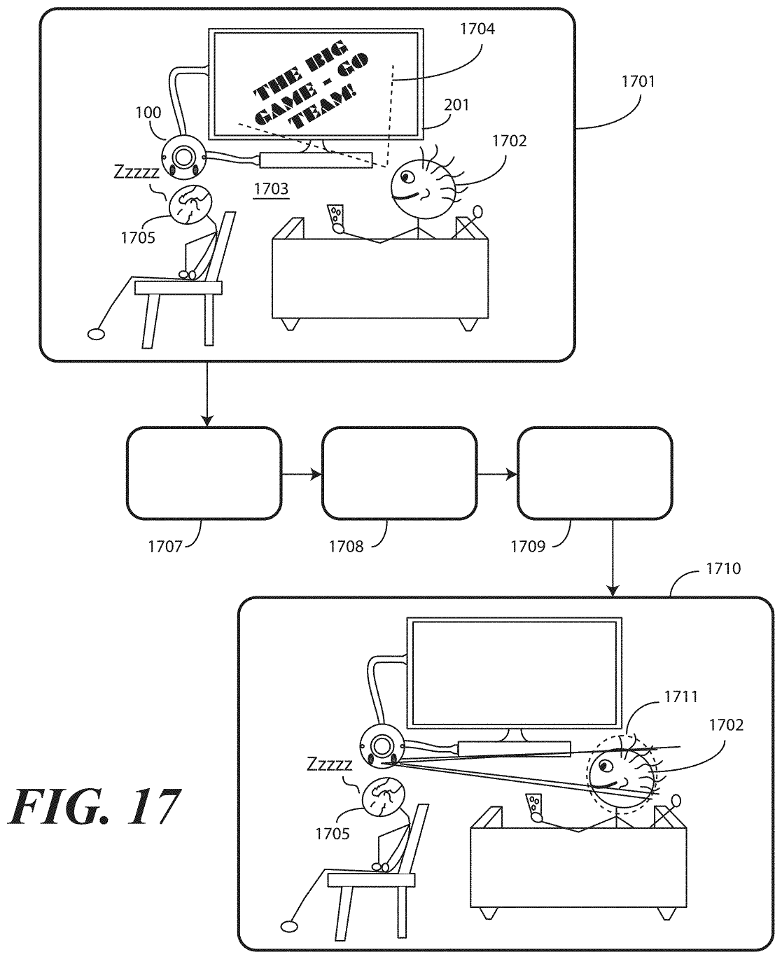

The method 1600 of FIG. 16 is shown graphically in FIG. 17. Turning now to FIG. 17, beginning at step 1701 an interface accessory 100 configured in accordance with one or more embodiments of the disclosure is coupled to a media consumption device 201. A person 1702 is seated on a sofa a first distance away from the media consumption device 201 within a predefined media consumption environment 1703. The interface accessory 100 monitors the person 1702 and detects a gaze cone 1704 toward the media consumption device 201.

At the same time, an older person 1705 is sitting in a chair 1706 a second distance from the media consumption device 201 within the predefined media consumption environment 1703. In this example, the older person 1705 is napping, and therefore is not gazing toward the media consumption device 201. Embodiments of the disclosure contemplate that in such situations, the older person 1705 may not wish to be disturbed, yet may want to remain in the room with person 1702 to enjoy their company. Alternatively, person 1702 may be a caregiver for the older person 1705.

In such a situation two persons are in the predefined media consumption environment 1703, one person, i.e., person 1702, is gazing toward the media consumption device 201, while the other person, person 1705, is napping. At step 1707, the interface accessory 100 determines, with the one or more sensors, a location of the person 1702 gazing toward the media consumption device 201. At step 1708, the interface accessory 100 delivers a control signal to the media consumption device 201 causing a cessation of any audio being output by the media consumption device 201. At step 1709, the interface accessory 100 delivers, with the ultrasound transducer array of the interface accessory 100, a beat audio output at the location of the at least person 1702 consuming the content. As shown at step 1710, person 1702 is listening to the beat frequency 1711 to enjoy audio of the content while person 1705 naps undisturbed.

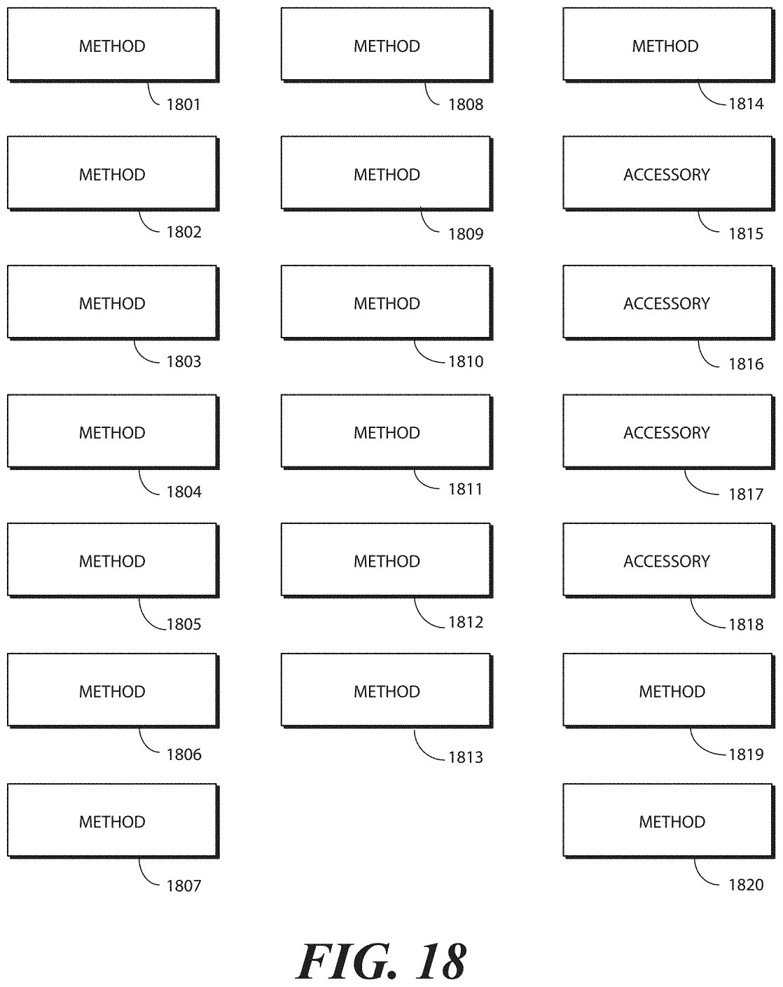

Turning now to FIG. 18, illustrated therein are various embodiments of the disclosure. At 1801, a method includes detecting, with one or more sensors of an interface accessory, one or more persons within a predefined media consumption environment of a media consumption device. At 1801, the method comprises identifying, with the one or more sensors of the interface accessory and in response to the detecting, at least one personal characteristic corresponding to at least one person of the one or more persons. At 1801, the method includes delivering, with one or more processors of the interface accessory, a control signal to an output connector of the interface accessory. At 1801, the control signal alters a content presentation characteristic of content being presented by the media consumption device when the output connector is coupled to the media consumption device.

At 1802, the at least one personal characteristic of 1801 comprises the at least one person being a minor. At 1803, the control signal of 1802 causes a pause of presentation of the content by the media consumption device.

At 1804, the at least one personal characteristic of 1803 further comprises a gaze of the at least one person toward the media consumption device. At 1804, the delivery of the control signal occurs only when the at least one person is gazing toward the media consumption device.

At 1805, the control signal of 1802 restricts which content offerings are available for consumption at the media consumption device. At 1806, the one or more persons of 1805 comprise at least two persons. At 1806, another personal characteristic corresponding to at least another person comprises the at least another person being an adult. Accordingly, at 1806, the method further comprises ceasing the restricting which content offerings are available for consumption at the media consumption device.

At 1807, the at least one personal characteristic of 1801 comprises the at least one person holding a remote control. At 1807, the control signal causes a predefined set of content offerings to be available for consumption at the media consumption device.

At 1808, the at least one personal characteristic comprises a lessened hearing condition. At 1808, the control signal causes adjustment of a volume level output by the media consumption device to a predefined level compensating for the lessened hearing condition.

At 1809, the one or more persons of 1801 comprise at least two persons. At 1809, the at least one personal characteristic comprises a distance from the media consumption device. At 1809, at least a first person is a first distance from the media consumption device and at least a second person is a second distance from the media consumption device. At 1809, the control signal causes adjustment of a volume level output by the media consumption device to optimize the volume level output for the at least a first person and the at least a second person.

At 1810, the method of 1809 further comprises determining, with the one or more sensors of the interface accessory, the at least one person of the one or more persons exiting the predefined media consumption environment. At 1810, the method comprises delivering, with the one or more processors, another control signal to the output connector causing another adjustment of the volume level output by the media consumption device.

At 1811, the one or more persons of 1801 comprise at least two persons. At 1811, the at least one personal characteristic comprises a gaze of the at least one person toward the media consumption device. At 1811, the control signal causes a cessation of audio output by the media consumption device. At 1811, the method further comprises determining, with the one or more sensors of the interface accessory, a location of the at least one person gazing toward the media consumption device. At 1811, the method further comprises delivering, with an ultrasound transducer array of the interface accessory, a beat audio output at the location of the at least one person.

At 1812, the at least one personal characteristic of 1801 comprises the at least one person leaving the predefined media consumption environment. At 1812, the control signal causes one or more of a pause of presentation of the content by the media consumption device or an adjustment of a volume level output by the media consumption device.

At 1813, the method of 1812 further comprises detecting at least one environmental characteristic of the predefined media consumption environment. At 1813, the delivery of the control signal occurs only when the at least one environmental characteristic is detected. At 1814, the at least one environmental characteristic of 1813 comprises at least one of a doorbell ring, a telephone ring, a door knock, a device command, or a conversation by the at least one person of the one or more persons.

At 1815, an interface accessory comprises a housing. At 1815, the interface accessory comprises one or more sensors. At 1815, the interface accessory comprises one or more processors operable with the one or more sensors. At 1815, the interface accessory comprises an output connector, mechanically and electrically connectable to a media consumption device.

At 1815, the one or more sensors monitor one or more persons within a predefined media consumption environment about the media consumption device. At 1815, the one or more processors deliver control signals to the output connector. At 1815, the control signals alter a content presentation characteristic of content being presented by the media consumption device as a function of one or more personal characteristics corresponding to the one or more persons when the output connector is coupled to the media consumption device.

At 1816, the control signals of 1815 pause presentation of the content or restrict content offerings when the one or more personal characteristics comprise at least one person being a minor. At 1817, the control signals adjust a volume of an audio output of the media consumption device when the one or more personal characteristics comprise a person entering or leaving the predefined media consumption environment.

At 1818, the interface accessory of 1815 further comprises an ultrasound transducer array. At 1818, the one or more persons of 1815 comprise at least a first person and at least a second person. At 1818, the control signals cause a cessation of audio output by the media consumption device. At 1818, the one or more processors further cause the ultrasound transducer array to deliver a beat audio output to the at least the first person that is inaudible to the at least the second person.

At 1819, a method comprises identifying, with one or more sensors of an interface accessory, one or more persons being within a predefined media consumption environment about a media consumption device. At 1819, the method comprises determining, by the one or more sensors, the one or more persons situating themselves at different distances relative to the media consumption device. At 1819, the method comprises averaging, by one or more processors operable with the one or more sensors, the different distances relative to the media consumption device for each person of the one or more persons. At 1819, the method comprises delivering, with the one or more processors operable with the one or more sensors, a control signal to an output connector of the interface accessory. At 1819, the control signal adjusts a volume level output by the media consumption device as a function of the different distances relative to the media consumption device when the output connector is coupled to the media consumption device.

At 1820, the method of 1819 further comprises detecting, by the one or more processors, an action of at least one person of the one or more persons precluding at least one person from consuming content from the media consumption device. At 1820, the method delivers another control signal causing a pause of presentation of the content by the media consumption device.

As shown and described above, an interface accessory can be configured with an imager, a depth imager, and a communication circuit. The interface accessory can monitor nearby people using the imager and facial recognition, microphones and voice recognition, beacons from companion devices, or other techniques. The interface accessory can pause the presentation of adult-oriented content when a minor is detected within a predefined media consumption environment and is gazing at a media consumption device. However, when the minor exits the predefined media consumption environment, the interface accessory can resume the presentation of the adult-oriented content.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. For example, in other use cases the interface accessory can mute the audio of adult-oriented content when a minor is detected within a predefined media consumption environment and is gazing at a media consumption device. However, when the minor exits the predefined media consumption environment, the interface accessory can unmute the audio of the adult-oriented content.

The interface accessory can monitor people within the predefined media consumption environment. When a person leaves the predefined media consumption environment, the interface accessory can pause the presentation of content. However, when the person returns to the predefined media consumption environment, the interface accessory can resume the presentation of the content.

In alternate use cases, the interface accessory can monitor people gazing at a media consumption device within a predefined media consumption environment. When one person leaves but others remain, rather than pausing the content, the interface accessory can remember a timeline associated with the content. When the one person returns, the interface accessory can fast rewind/play any missed part as not to waste the other people's time.

The interface accessory can adjust the volume or brightness of a media consumption device as a function of distance from the media consumption device. Illustrating by example, the interface accessory can increases the volume output level when a person consuming content moves further from a media consumption device. When the person moves farther from the media consumption device, the interface accessory can revert to a lower volume output level when returning.

If a single person is present within the predefined media consumption environment, the interface accessory can analyze that person's behavior in the predefined media consumption environment. If the person stops gazing at the media consumption device, e.g., begins making/taking a telephone call, looking at a phone, or chatting with someone else, the interface accessory can remember the timeline of the content presentation beginning from when the person stopped gazing at the media consumption device. The interface accessory can then ask the person if he wants to play from where he was watching prior to getting distracted. If more than one person is watching the content, the interface accessory can remember the timeline when each person started doing something else and provided an option to replay the session where they missed.

The interface accessory can restrict channel selection viewing access based on the imager capturing images of a person gazing toward the media consumption device while carrying an input device, such as a remote control in the hand or a fob into which the person is speaking, thereby making certain movies not playable. The interface accessory can then un-restrict access when it detects a minor gazing toward the media consumption device and carrying the input device if an adult is detected also gazing toward the media consumption device, thereby seamlessly bypassing minor's restriction.

The interface accessory can maintain a constant volume output level if persons consuming content from a media consumption device are clustered close together and some leave or come. When the sound of ringing bell or ringing phone, or conversing people, is detected, the interface accessory can momentarily lower the volume.

The interface accessory can be aware of content consumption histories of an identified user and can preserve the setting for a next time. Setting examples include a preferred volume or brightness level based on the identity of the person, their sitting location, brightness theme, etc.

In one or more embodiments the interface accessory has the ability to learn user preferences, e.g., who, where, when, what, what they are wearing, when are they home, what they watch, their voices, laughter, shouting, etc. The interface accessory also has the ability, in one embodiment, to download from other mobile devices and/or wearables an AI learned history.

It should be noted that while shown as a device coupled to a media consumption device in the figures set forth above, the interface accessory could also be integrated into the media consumption device as well.

In one embodiment, the interface accessory can remember the user watching habits and/or programs that a particular user prefers. This data can be stored and analyzed to help content recommendation for users and automate/initiate program selections when the user is detected and identified. The interface accessory can be configured as a stationary device including a display, cameras, microphones, speakers and one or more processors to observe people in its proximity using the microphones and cameras and builds a profile of individual preferences on lighting, sound level, age appropriateness, and account login information.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method, comprising:
detecting, with one or more sensors of an interface accessory, one or more persons within a predefined media consumption environment of a media consumption device;
identifying, with the one or more sensors of the interface accessory and in response to the detecting, at least one personal characteristic corresponding to at least one person of the one or more persons; and
delivering, with one or more processors of the interface accessory, a control signal to an output connector of the interface accessory, the control signal altering a content presentation characteristic of content being presented by the media consumption device when the output connector is coupled to the media consumption device.

2. The method of claim 1, the at least one personal characteristic comprising the at least one person being a minor.

3. The method of claim 2, the control signal causing a pause of presentation of the content by the media consumption device.

4. The method of claim 3, the at least one personal characteristic further comprising a gaze of the at least one person toward the media consumption device, the delivering of the control signal occurring only when the at least one person is gazing toward the media consumption device.

5. The method of claim 2, the control signal restricting which content offerings are available for consumption at the media consumption device.

6. The method of claim 5, the one or more persons comprising at least two persons, wherein another personal characteristic corresponding to at least another person comprises the at least another person being an adult, the method further comprising ceasing the restricting which content offerings are available for consumption at the media consumption device.

7. The method of claim 1, the at least one personal characteristic comprising the at least one person holding a remote control, the control signal causing a predefined set of content offerings to be available for consumption at the media consumption device.

8. The method of claim 1, the at least one personal characteristic comprising a lessened hearing condition, the control signal causing adjustment of a volume level output by the media consumption device to a predefined level compensating for the lessened hearing condition.

9. The method of claim 1, the one or more persons comprising at least two persons, the at least one personal characteristic comprising a distance from the media consumption device, wherein at least a first person is a first distance from the media consumption device and at least a second person is a second distance from the media consumption device, the control signal causing adjustment of a volume level output by the media consumption device to optimize the volume level output for the at least a first person and the at least a second person.

10. The method of claim 9, further comprising determining, with the one or more sensors of the interface accessory, the at least one person of the one or more persons exiting the predefined media consumption environment and delivering, with the one or more processors, another control signal to the output connector causing another adjustment of the volume level output by the media consumption device.

11. The method of claim 1, the one or more persons comprising at least two persons, the at least one personal characteristic comprising a gaze of the at least one person toward the media consumption device, the control signal causing a cessation of audio output by the media consumption device, the method further comprising:
determining, with the one or more sensors of the interface accessory, a location of the at least one person gazing toward the media consumption device; and
delivering, with an ultrasound transducer array of the interface accessory, a beat audio output at the location of the at least one person.

12. The method of claim 1, the at least one personal characteristic comprising the at least one person leaving the predefined media consumption environment, the control signal causing one or more of a pause of presentation of the content by the media consumption device or an adjustment of a volume level output by the media consumption device.

13. The method of claim 12, the method further comprising detecting at least one environmental characteristic of the predefined media consumption environment, the delivering of the control signal occurring only when the at least one environmental characteristic is detected.

14. The method of claim 13, the at least one environmental characteristic comprising at least one of a doorbell ring, a telephone ring, a door knock, a device command, or a conversation by the at least one person of the one or more persons.

15. An interface accessory, comprising:
a housing;
one or more sensors;
one or more processors operable with the one or more sensors;
an output connector, mechanically and electrically connectable to a media consumption device;
the one or more sensors monitoring one or more persons within a predefined media consumption environment about the media consumption device; and
the one or more processors delivering control signals to the output connector, the control signals altering a content presentation characteristic of content being presented by the media consumption device as a function of one or more personal characteristics corresponding to the one or more persons when the output connector is coupled to the media consumption device.

16. The interface accessory of claim 15, the control signals pausing presentation of the content or restricting content offerings when the one or more personal characteristics comprise at least one person being a minor.

17. The interface accessory of claim 15, the control signals adjusting a volume of an audio output of the media consumption device when the one or more personal characteristics comprise a person entering or leaving the predefined media consumption environment.

18. The interface accessory of claim 15, further comprising an ultrasound transducer array, the one or more persons comprising at least a first person and at least a second person, the control signals causing a cessation of audio output by the media consumption device, the one or more processors further causing the ultrasound transducer array to deliver a beat audio output to the at least the first person that is inaudible to the at least the second person.

19. A method, comprising:
identifying, with one or more sensors of an interface accessory, one or more persons being within a predefined media consumption environment about a media consumption device;
determining, by the one or more sensors, the one or more persons situating themselves at different distances relative to the media consumption device;
averaging, by one or more processors operable with the one or more sensors, the different distances relative to the media consumption device for each person of the one or more persons; and
delivering, with the one or more processors operable with the one or more sensors, a control signal to an output connector of the interface accessory, the control signal adjusting a volume level output by the media consumption device as a function of the different distances relative to the media consumption device when the output connector is coupled to the media consumption device.

20. The method of claim 19, further comprising detecting, by the one or more processors, an action of at least one person of the one or more persons precluding at least one person from consuming content from the media consumption device, and delivering another control signal causing a pause of presentation of the content by the media consumption device.
